(19) United States
(12) Patent Application Publication
(10) Pub. No.: US 2026/0010405 A1
(43) Pub. Date: Jan. 8, 2026

(54) Orchestrating Execution Of Resource Modification Operations

(71) Applicant: Oracle International Corporation, Redwood Shores, CA (US)

(72) Inventors: Joshua Allen Roldstad, Brier, WA (US); Chong Zhang, Bellevue, WA (US); Chenxi Liu, Sammamish, WA (US); Stephen Craig Drye, Arlington, MA (US)

(73) Assignee: Oracle International Corporation, Redwood Shores, CA (US)

(21) Appl. No.: 18/763,024

(22) Filed: Jul. 3, 2024

(51) Int. Cl. G06F 9/50; G06F 9/455

(52) U.S. Cl. CPC G06F 9/5038; G06F 9/45558; G06F 9/5072; G06F 2009/45595; G06F 2209/501; G06F 2209/5022

(57) ABSTRACT

A system receives a first request to execute a resource modification operation on any resources that meet a set of one or more resource selection criteria as of a time corresponding to the resource modification operation. The system stores the resource modification operation in association with the set of one or more resource selection criteria and the time. Responsive to detecting the time, the system executes a resource identification operation based on the set of one or more resource selection criteria to identify a resource, associated with a set of one or more attributes that satisfy the set of one or more resource selection criteria. Upon having identified the resource, the system initiates execution of the resource modification operation upon the resource to modify a configuration corresponding to the resource.

### TECHNICAL FIELD

The present disclosure relates to orchestrating operations for modifying resources such as resources executing in a cloud computing environment.

### BACKGROUND

A computing environment, such as a cloud computing environment, includes various resources, such as compute instances, database instances, and services. The various resources of a computing environment can be managed by service providers and/or users in pursuit of various objectives, including improving performance, controlling costs, and/or addressing operational concerns. The content of this background section should not be construed as prior art merely by virtue of its presence in this section.

### BRIEF DESCRIPTION OF THE DRAWINGS

The embodiments are illustrated by way of example and not by way of limitation in the figures of the accompanying drawings. References to “an” or “one” embodiment in this disclosure are not necessarily to the same embodiment and refer to at least one embodiment. In the drawings:

FIGS. 1-4 are block diagrams illustrating patterns for implementing a cloud infrastructure as a service system in accordance with one or more embodiments;

FIG. 5 is a hardware system in accordance with one or more embodiments;

FIG. 6A illustrates features of an example system for orchestrating resource modifications in accordance with one or more embodiments;

FIG. 6B illustrates features of an example resource modification schedule that may be included in the system of FIG. 6A in accordance with one or more embodiments;

FIG. 6C illustrates features of an example workflow schedule that may be included in the system of FIG. 6A in accordance with one or more embodiments;

FIGS. 7A-7D are flowcharts that illustrate example operations pertaining to orchestrating resource modifications in accordance with one or more embodiments;

FIGS. 8A and 8B are flowcharts that illustrate example operations pertaining to generating resource modification schedules in accordance with one or more embodiments; and

FIGS. 8C and 8D are flowcharts that illustrate example operations pertaining to generating workflow schedules in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.
1. GENERAL OVERVIEW
2. CLOUD COMPUTING TECHNOLOGY
3. COMPUTER SYSTEM
4. SYSTEM ARCHITECTURE FOR ORCHESTRATING EXECUTION OF RESOURCE MODIFICATION OPERATIONS
5. EXAMPLE PROCESSES FOR ORCHESTRATING EXECUTION OF RESOURCE MODIFICATION OPERATIONS
6. MISCELLANEOUS; EXTENSIONS

### 1. GENERAL OVERVIEW

A system includes a resource modification orchestrator that orchestrates execution of resource modification operations on sets of resources that meet one or more resource selection criteria. The resource selection criteria for a resource modification operation are evaluated as of approximately a time when the resource modification operation is to be executed. Accordingly, the particular resources that are subjected to the resource modification operation depend on whether the one or more resource selection criteria are satisfied when the one or more resource selection criteria are evaluated. The resource modification operations may include initiating execution or pausing execution of any resources that satisfy a set of resource selection criteria as of a scheduled time. Additional resource modification operations are described herein.

In one example, a resource that does not satisfy resource selection criteria for a resource modification operation when the resource modification operation is scheduled may subsequently satisfy the resource selection criteria when the resource selection criteria is evaluated. Even though the resource did not satisfy the resource selection criteria when the resource modification operation was scheduled, the resource modification operation is applied to the resource because the resource satisfied the resource selection criteria at the time of evaluation. In another example, a resource that is provisioned subsequent to scheduling the resource modification operation satisfies the resource selection criteria. Even though the resource was not yet provisioned when the resource modification operation was scheduled, the resource modification operation is applied to the resource because the resource satisfied the resource selection criteria at the time of evaluation.

In one example, the one or more resource selection criteria are based on attributes associated with the resources. The attributes may be represented in metadata elements, such as tags, associated with resources. The system may evaluate the resource selection criteria by executing a query or a filter upon a resource attribute data corpus to identify resources that satisfy the resource selection criteria. The query or filter may provide a set of resources that have attributes that satisfy the resource selection criteria. In one example, attributes associated with a resource may change over time, for example, due to the dynamic nature of the computing environment, where the resource is provisioned and/or due to the state of the resource itself. Additionally, or alternatively, the system may change attributes associated with a resource, for example, based on an input from an operator device interface and/or based on a trigger condition associated with an operation of the computing environment and/or the resource. The system may represent changes associated with an attribute of a resource by adding, removing, or modifying metadata elements, such as tags, associated with the resource. In one example, attributes associated with a resource that satisfy the resource selection criteria when a resource modification operation is scheduled may no longer satisfy the resource selection criteria when the resource selection criteria is evaluated. Additionally, or alternatively, attributes associated with a resource that did not satisfy the resource selection criteria when the resource modification operation is scheduled may satisfy the resource selection criteria when the resource selection criteria is evaluated. Additionally, or alternatively, attributes associated with a resource that is provisioned after the resource modification operation is scheduled, and prior to evaluation of the resource selection criteria, may satisfy the resource selection criteria when the one or more resource selection criteria are evaluated. By querying or filtering the resources against the resource selection criteria based on attributes of the resources, the system includes any resources that have attributes that satisfy the resource selection criteria as of the time when the resource selection criteria is evaluated.

In one example, the system orchestrates execution of resource modification operations utilizing a process that includes generating schedule entries in a resource modification schedule and generating work requests in a workflow schedule. Additionally, the process for orchestrating execution of the resource modification operations includes generating workflow instances to execute the work requests in the workflow schedule. The resource modification schedule includes a set of schedule entries with specified times for executing resource modification operations on resources that satisfy resource selection criteria corresponding to the schedule entries as of the specified time in the resource modification schedule. The workflow schedule includes a set of work requests for a set of workflow instances to execute resource modification operations on resources that satisfy the resource selection criteria corresponding to a schedule entry in the resource modification schedule.

The system may utilize one or more resource modification schedules and one or more workflow schedules. In one example, the system scales the quantity of resource modification schedules based on a rate of receiving requests to execute resource modification operations. The requests may originate from an operator device interface and/or from a resource modification orchestrator. Additionally, or alternatively, the system may generate an additional resource modification schedule when a count of schedule entries in one or more existing resource modification schedules meets a threshold.

The system may utilize one or more workflow schedules. In one example, the system scales the quantity of workflow schedules based on a rate of generating workflow instances to execute resource modification operations. Additionally, or alternatively, the system may scale the quantity of workflow schedules based on a rate of generating additional resource modification schedules. Additionally, or alternatively, the system may generate an additional workflow schedule when a count of the work requests for a workflow instance to execute a workflow that includes a resource modification operation meets a threshold.

The system may allocate one or more work requests to a particular workflow instance. In one example, the system generates a workflow instance for each particular resource modification operation to be executed upon a particular resource. Additionally, or alternatively, the system may allocate multiple resource modification operations to a particular workflow instance. The multiple resource modification operation allocated to the particular workflow instance may be executed upon one or more resources. In one example, the system determines a number of workflow instances to be generated based on a count of the resources scheduled to receive a resource modification operation.

One or more embodiments described in this Specification and/or recited in the claims may not be included in this General Overview section.

### 2. CLOUD COMPUTING TECHNOLOGY

Infrastructure as a Service (IaaS) is an application of cloud computing technology. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components; example services include billing software, monitoring software, logging software, load balancing software, clustering software, etc. Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on the VMs, deploy middleware such as databases, create storage buckets for workloads and backups, and install enterprise software into that VM. Customers can then use the provider's services to perform various functions, including balancing network traffic, troubleshooting application issues, monitoring performance, and managing disaster recovery, etc.

In some cases, a cloud computing model will involve the participation of a cloud provider. The cloud provider may, but need not, be a third-party service that specializes in providing (e.g., offering, renting, selling) IaaS. An entity may also opt to deploy a private cloud, becoming its own provider of infrastructure services.

In some examples, IaaS deployment is the process of implementing a new application, or a new version of an application, onto a prepared application server or other similar device. IaaS deployment may also include the process of preparing the server (e.g., installing libraries, daemons, etc.). The deployment process is often managed by the cloud provider below the hypervisor layer (e.g., the servers, storage, network hardware, and virtualization). Thus, the customer may be responsible for handling (OS), middleware, and/or application deployment such as on self-service virtual machines. The self-service virtual machines can be spun up on demand.

In some examples, IaaS provisioning may refer to acquiring computers or virtual hosts for use, even installing needed libraries or services on them. In most cases, deployment does not include provisioning, and the provisioning may need to be performed first.

In some cases, there are challenges for IaaS provisioning. There is an initial challenge of provisioning the initial set of infrastructure. There is an additional challenge of evolving the existing infrastructure (e.g., adding new services, changing services, removing services, etc.) after the initial provisioning is completed. In some cases, these challenges may be addressed by enabling the configuration of the infrastructure to be defined declaratively. In other words, the infrastructure (e.g., what components are needed and how components interact) can be defined by one or more configuration files. Thus, the overall topology of the infrastructure (e.g., what resources depend on one another and how resources work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up for one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). In some embodiments, infrastructure and resources may be provisioned (manually and/or using a provisioning tool) prior to deployment of code to be executed on the infrastructure. However, in some examples, the infrastructure that will deploy the code may first be set up. In some instances, the provisioning can be done manually, a provisioning tool may be utilized to provision the resources, and/or deployment tools may be utilized to deploy the code once the infrastructure is provisioned.

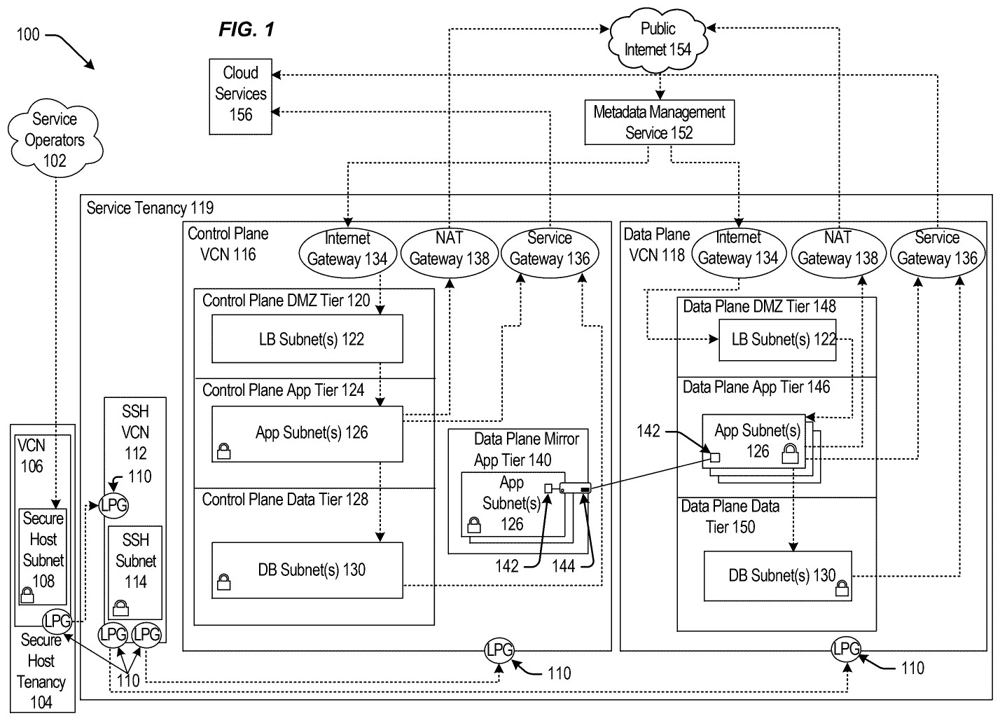

FIG. 1 is a block diagram illustrating an example pattern of an IaaS architecture 100 according to at least one embodiment. Service operators 102 can be communicatively coupled to a secure host tenancy 104 that can include a virtual cloud network (VCN) 106 and a secure host subnet 108. In some examples, the service operators 102 may be using one or more client computing devices, such as portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers, including personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems such as Google Chrome OS. Additionally, or alternatively, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 106 and/or the Internet.

The VCN 106 can include a local peering gateway (LPG) 110 that can be communicatively coupled to a secure shell (SSH) VCN 112 via an LPG 110 contained in the SSH VCN 112. The SSH VCN 112 can include an SSH subnet 114, and the SSH VCN 112 can be communicatively coupled to a control plane VCN 116 via the LPG 110 contained in the control plane VCN 116. Also, the SSH VCN 112 can be communicatively coupled to a data plane VCN 118 via an LPG 110. The control plane VCN 116 and the data plane VCN 118 can be contained in a service tenancy 119 that can be owned and/or operated by the IaaS provider.

The control plane VCN 116 can include a control plane demilitarized zone (DMZ) tier 120 that acts as a perimeter network (e.g., portions of a corporate network between the corporate intranet and external networks). The DMZ-based servers may have restricted responsibilities and help keep breaches contained. Additionally, the DMZ tier 120 can include one or more load balancer (LB) subnet(s) 122, a control plane app tier 124 that can include app subnet(s) 126, a control plane data tier 128 that can include database (DB) subnet(s) 130 (e.g., frontend DB subnet(s) and/or backend DB subnet(s)). The LB subnet(s) 122 contained in the control plane DMZ tier 120 can be communicatively coupled to the app subnet(s) 126 contained in the control plane app tier 124 and an Internet gateway 134 that can be contained in the control plane VCN 116. The app subnet(s) 126 can be communicatively coupled to the DB subnet(s) 130 contained in the control plane data tier 128 and a service gateway 136 and a network address translation (NAT) gateway 138. The control plane VCN 116 can include the service gateway 136 and the NAT gateway 138.

The control plane VCN 116 can include a data plane mirror app tier 140 that can include app subnet(s) 126. The app subnet(s) 126 contained in the data plane mirror app tier 140 can include a virtual network interface controller (VNIC) 142 that can execute a compute instance 144. The compute instance 144 can communicatively couple the app subnet(s) 126 of the data plane mirror app tier 140 to app subnet(s) 126 that can be contained in a data plane app tier 146.

The data plane VCN 118 can include the data plane app tier 146, a data plane DMZ tier 148, and a data plane data tier 150. The data plane DMZ tier 148 can include LB subnet(s) 122 that can be communicatively coupled to the app subnet(s) 126 of the data plane app tier 146 and the Internet gateway 134 of the data plane VCN 118. The app subnet(s) 126 can be communicatively coupled to the service gateway 136 of the data plane VCN 118 and the NAT gateway 138 of the data plane VCN 118. The data plane data tier 150 can also include the DB subnet(s) 130 that can be communicatively coupled to the app subnet(s) 126 of the data plane app tier 146.

The Internet gateway 134 of the control plane VCN 116 and of the data plane VCN 118 can be communicatively coupled to a metadata management service 152 that can be communicatively coupled to public Internet 154. Public Internet 154 can be communicatively coupled to the NAT gateway 138 of the control plane VCN 116 and of the data plane VCN 118. The service gateway 136 of the control plane VCN 116 and of the data plane VCN 118 can be communicatively couple to cloud services 156.

In some examples, the service gateway 136 of the control plane VCN 116 or of the data plane VCN 118 can make application programming interface (API) calls to cloud services 156 without going through public Internet 154. The API calls to cloud services 156 from the service gateway 136 can be one-way; the service gateway 136 can make API calls to cloud services 156, and cloud services 156 can send requested data to the service gateway 136. However, cloud services 156 may not initiate API calls to the service gateway 136.

In some examples, the secure host tenancy 104 can be directly connected to the service tenancy 119. The service tenancy 119 may otherwise be isolated. The secure host subnet 108 can communicate with the SSH subnet 114 through an LPG 110 that may enable two-way communication over an otherwise isolated system. Connecting the secure host subnet 108 to the SSH subnet 114 may give the secure host subnet 108 access to other entities within the service tenancy 119.

The control plane VCN 116 may allow users of the service tenancy 119 to set up or otherwise provision desired resources. Desired resources provisioned in the control plane VCN 116 may be deployed or otherwise used in the data plane VCN 118. In some examples, the control plane VCN 116 can be isolated from the data plane VCN 118, and the data plane mirror app tier 140 of the control plane VCN 116 can communicate with the data plane app tier 146 of the data plane VCN 118 via VNICs 142 that can be contained in the data plane mirror app tier 140 and the data plane app tier 146.

In some examples, users of the system, or customers, can make requests, for example create, read, update, or delete (CRUD) operations, through public Internet 154 that can communicate the requests to the metadata management service 152. The metadata management service 152 can communicate the request to the control plane VCN 116 through the Internet gateway 134. The request can be received by the LB subnet(s) 122 contained in the control plane DMZ tier 120. The LB subnet(s) 122 may determine that the request is valid, and in response, the LB subnet(s) 122 can transmit the request to app subnet(s) 126 contained in the control plane app tier 124. If the request is validated and requires a call to public Internet 154, the call to public Internet 154 may be transmitted to the NAT gateway 138 that can make the call to public Internet 154. Metadata that may be desired to be stored by the request can be stored in the DB subnet(s) 130.

In some examples, the data plane mirror app tier 140 can facilitate direct communication between the control plane VCN 116 and the data plane VCN 118. For example, changes, updates, or other suitable modifications to configuration may be desired to be applied to the resources contained in the data plane VCN 118. Via a VNIC 142, the control plane VCN 116 can directly communicate with, and can thereby execute the changes, updates, or other suitable modifications to configuration to, resources contained in the data plane VCN 118.

In some embodiments, the control plane VCN 116 and the data plane VCN 118 can be contained in the service tenancy 119. In this case, the user, or the customer, of the system may not own or operate either the control plane VCN 116 or the data plane VCN 118. Instead, the IaaS provider may own or operate the control plane VCN 116 and the data plane VCN 118. The control plane VCN 116 and the data plane VCN 118 may be contained in the service tenancy 119. This embodiment can enable isolation of networks that may prevent users or customers from interacting with other users', or other customers', resources. Also, this embodiment may allow users or customers of the system to store databases privately without needing to rely on public Internet 154 for storage.

In other embodiments, the LB subnet(s) 122 contained in the control plane VCN 116 can be configured to receive a signal from the service gateway 136. In this embodiment, the control plane VCN 116 and the data plane VCN 118 may be configured to be called by a customer of the IaaS provider without calling public Internet 154. Customers of the IaaS provider may desire this embodiment since database(s) that the customers use may be controlled by the IaaS provider and may be stored on the service tenancy 119. The service tenancy 119 may be isolated from public Internet 154.

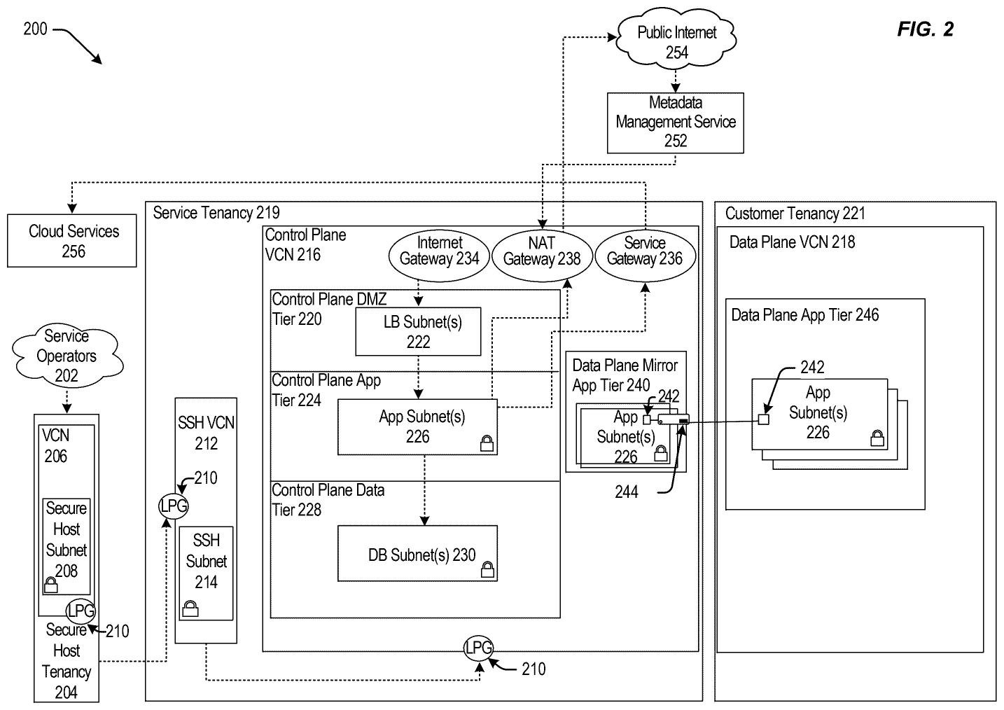

FIG. 2 is a block diagram illustrating another example pattern of an IaaS architecture 200 according to at least one embodiment. Service operators 202 (e.g., service operators 102 of FIG. 1) can be communicatively coupled to a secure host tenancy 204 (e.g., the secure host tenancy 104 of FIG. 1) that can include a virtual cloud network (VCN) 206 (e.g., the VCN 106 of FIG. 1) and a secure host subnet 208 (e.g., the secure host subnet 108 of FIG. 1). The VCN 206 can include a local peering gateway (LPG) 210 (e.g., the LPG 110 of FIG. 1) that can be communicatively coupled to a secure shell (SSH) VCN 212 (e.g., the SSH VCN 112 of FIG. 1) via an LPG 110 contained in the SSH VCN 212. The SSH VCN 212 can include an SSH subnet 214 (e.g., the SSH subnet 114 of FIG. 1), and the SSH VCN 212 can be communicatively coupled to a control plane VCN 216 (e.g., the control plane VCN 116 of FIG. 1) via an LPG 210 contained in the control plane VCN 216. The control plane VCN 216 can be contained in a service tenancy 219 (e.g., the service tenancy 119 of FIG. 1), and the data plane VCN 218 (e.g., the data plane VCN 118 of FIG. 1) can be contained in a customer tenancy 221 that may be owned or operated by users, or customers, of the system.

The control plane VCN 216 can include a control plane DMZ tier 220 (e.g., the control plane DMZ tier 120 of FIG. 1) that can include LB subnet(s) 222 (e.g., LB subnet(s) 122 of FIG. 1), a control plane app tier 224 (e.g., the control plane app tier 124 of FIG. 1) that can include app subnet(s) 226 (e.g., app subnet(s) 126 of FIG. 1), and a control plane data tier 228 (e.g., the control plane data tier 128 of FIG. 1) that can include database (DB) subnet(s) 230 (e.g., similar to DB subnet(s) 130 of FIG. 1). The LB subnet(s) 222 contained in the control plane DMZ tier 220 can be communicatively coupled to the app subnet(s) 226 contained in the control plane app tier 224 and an Internet gateway 234 (e.g., the Internet gateway 134 of FIG. 1) that can be contained in the control plane VCN 216. The app subnet(s) 226 can be communicatively coupled to the DB subnet(s) 230 contained in the control plane data tier 228 and a service gateway 236 (e.g., the service gateway 136 of FIG. 1) and a network address translation (NAT) gateway 238 (e.g., the NAT gateway 138 of FIG. 1). The control plane VCN 216 can include the service gateway 236 and the NAT gateway 238.

The control plane VCN 216 can include a data plane mirror app tier 240 (e.g., the data plane mirror app tier 140 of FIG. 1) that can include app subnet(s) 226. The app subnet(s) 226 contained in the data plane mirror app tier 240 can include a virtual network interface controller (VNIC) 242 (e.g., the VNIC of 142) that can execute a compute instance 244 (e.g., similar to the compute instance 144 of FIG. 1). The compute instance 244 can facilitate communication between the app subnet(s) 226 of the data plane mirror app tier 240 and the app subnet(s) 226 that can be contained in a data plane app tier 246 (e.g., the data plane app tier 146 of FIG. 1) via the VNIC 242 contained in the data plane mirror app tier 240 and the VNIC 242 contained in the data plane app tier 246.

The Internet gateway 234 contained in the control plane VCN 216 can be communicatively coupled to a metadata management service 252 (e.g., the metadata management service 152 of FIG. 1) that can be communicatively coupled to public Internet 254 (e.g., public Internet 154 of FIG. 1). Public Internet 254 can be communicatively coupled to the NAT gateway 238 contained in the control plane VCN 216. The service gateway 236 contained in the control plane VCN 216 can be communicatively couple to cloud services 256 (e.g., cloud services 156 of FIG. 1).

In some examples, the data plane VCN 218 can be contained in the customer tenancy 221. In this case, the IaaS provider may provide the control plane VCN 216 per customer, and the IaaS provider may, for the customer, set up a unique, compute instance 244 that is contained in the service tenancy 219. Compute instance 244 may allow communication between the control plane VCN 216 contained in the service tenancy 219 and the data plane VCN 218 that is contained in the customer tenancy 221. The compute instance 244 may allow resources provisioned in the control plane VCN 216 that is contained in the service tenancy 219 to be deployed or otherwise used in the data plane VCN 218 that is contained in the customer tenancy 221.

In other examples, the customer of the IaaS provider may have databases that live in the customer tenancy 221. In this example, the control plane VCN 216 can include the data plane mirror app tier 240 that can include app subnet(s) 226. The data plane mirror app tier 240 can reside in the data plane VCN 218, but the data plane mirror app tier 240 may not live in the data plane VCN 218. That is, the data plane mirror app tier 240 may have access to the customer tenancy 221, but the data plane mirror app tier 240 may not exist in the data plane VCN 218 or be owned or operated by the customer of the IaaS provider. The data plane mirror app tier 240 may be configured to make calls to the data plane VCN 218 but may not be configured to make calls to any entity contained in the control plane VCN 216. The customer may desire to deploy or otherwise use resources in the data plane VCN 218 that are provisioned in the control plane VCN 216, and the data plane mirror app tier 240 can facilitate the desired deployment or other usage of resources of the customer.

In some embodiments, the customer of the IaaS provider can apply filters to the data plane VCN 218. In this embodiment, the customer can determine what the data plane VCN 218 can access, and the customer may restrict access to public Internet 254 from the data plane VCN 218. The IaaS provider may not be able to apply filters or otherwise control access of the data plane VCN 218 to any outside networks or databases. Applying filters and controls by the customer onto the data plane VCN 218, contained in the customer tenancy 221, can help isolate the data plane VCN 218 from other customers and from public Internet 254.

In some embodiments, cloud services 256 can be called by the service gateway 236 to access services that may not exist on public Internet 254, on the control plane VCN 216, or on the data plane VCN 218. The connection between cloud services 256 and the control plane VCN 216 or the data plane VCN 218 may not be live or continuous. Cloud services 256 may exist on a different network owned or operated by the IaaS provider. Cloud services 256 may be configured to receive calls from the service gateway 236 and may be configured to not receive calls from public Internet 254. Some cloud services 256 may be isolated from other cloud services 256, and the control plane VCN 216 may be isolated from cloud services 256 that may not be in the same region as the control plane VCN 216. For example, the control plane VCN 216 may be located in “Region 1,” and cloud service “Deployment 1” may be located in Region 1 and in “Region 2.” If a call to Deployment 1 is made by the service gateway 236 contained in the control plane VCN 216 located in Region 1, the call may be transmitted to Deployment 1 in Region 1. In this example, the control plane VCN 216, or Deployment 1 in Region 1, may not be communicatively coupled to, or otherwise in communication with, Deployment 1 in Region 2.

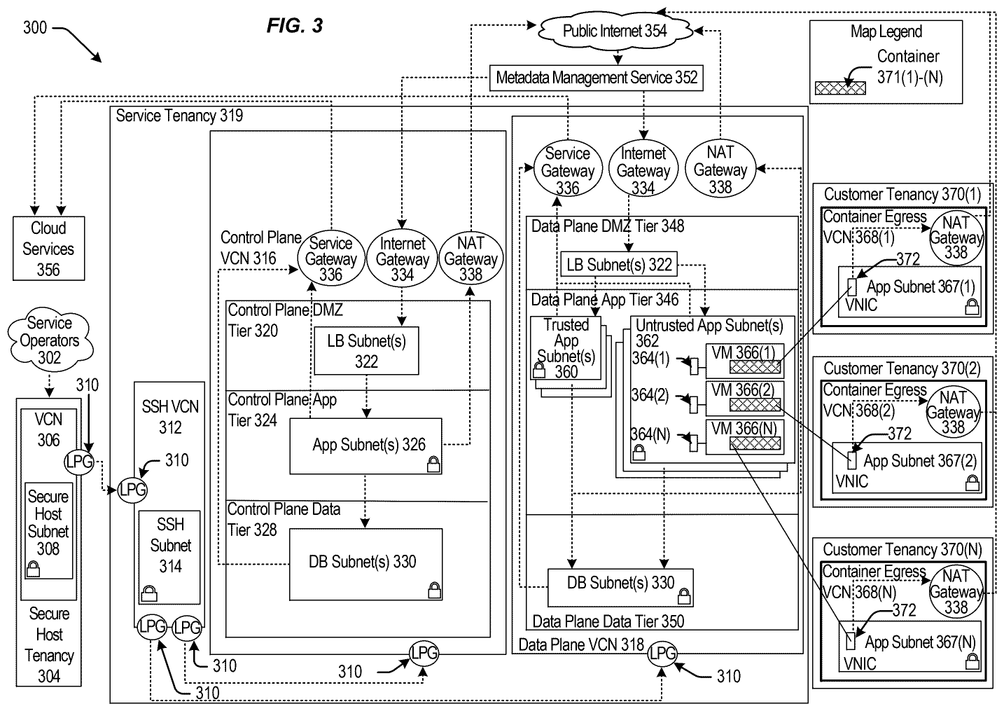

FIG. 3 is a block diagram illustrating another example pattern of an IaaS architecture 300 according to at least one embodiment. Service operators 302 (e.g., service operators 102 of FIG. 1) can be communicatively coupled to a secure host tenancy 304 (e.g., the secure host tenancy 104 of FIG. 1) that can include a virtual cloud network (VCN) 306 (e.g., the VCN 106 of FIG. 1) and a secure host subnet 308 (e.g., the secure host subnet 108 of FIG. 1). The VCN 306 can include an LPG 310 (e.g., the LPG 110 of FIG. 1) that can be communicatively coupled to an SSH VCN 312 (e.g., the SSH VCN 112 of FIG. 1) via an LPG 310 contained in the SSH VCN 312. The SSH VCN 312 can include an SSH subnet 314 (e.g., the SSH subnet 114 of FIG. 1), and the SSH VCN 312 can be communicatively coupled to a control plane VCN 316 (e.g., the control plane VCN 116 of FIG. 1) via an LPG 310 contained in the control plane VCN 316 and to a data plane VCN 318 (e.g., the data plane VCN 118 of FIG. 1) via an LPG 310 contained in the data plane VCN 318. The control plane VCN 316 and the data plane VCN 318 can be contained in a service tenancy 319 (e.g., the service tenancy 119 of FIG. 1).

The control plane VCN 316 can include a control plane DMZ tier 320 (e.g., the control plane DMZ tier 120 of FIG. 1) that can include load balancer (LB) subnet(s) 322 (e.g., LB subnet(s) 122 of FIG. 1), a control plane app tier 324 (e.g., the control plane app tier 124 of FIG. 1) that can include app subnet(s) 326 (e.g., similar to app subnet(s) 126 of FIG. 1), and a control plane data tier 328 (e.g., the control plane data tier 128 of FIG. 1) that can include DB subnet(s) 330. The LB subnet(s) 322 contained in the control plane DMZ tier 320 can be communicatively coupled to the app subnet(s) 326 contained in the control plane app tier 324 and to an Internet gateway 334 (e.g., the Internet gateway 134 of FIG. 1) that can be contained in the control plane VCN 316, and the app subnet(s) 326 can be communicatively coupled to the DB subnet(s) 330 contained in the control plane data tier 328 and to a service gateway 336 (e.g., the service gateway of FIG. 1) and a network address translation (NAT) gateway 338 (e.g., the NAT gateway 138 of FIG. 1). The control plane VCN 316 can include the service gateway 336 and the NAT gateway 338.

The data plane VCN 318 can include a data plane app tier 346 (e.g., the data plane app tier 146 of FIG. 1), a data plane DMZ tier 348 (e.g., the data plane DMZ tier 148 of FIG. 1), and a data plane data tier 350 (e.g., the data plane data tier 150 of FIG. 1). The data plane DMZ tier 348 can include LB subnet(s) 322 that can be communicatively coupled to trusted app subnet(s) 360, untrusted app subnet(s) 362 of the data plane app tier 346, and the Internet gateway 334 contained in the data plane VCN 318. The trusted app subnet(s) 360 can be communicatively coupled to the service gateway 336 contained in the data plane VCN 318, the NAT gateway 338 contained in the data plane VCN 318, and DB subnet(s) 330 contained in the data plane data tier 350. The untrusted app subnet(s) 362 can be communicatively coupled to the service gateway 336 contained in the data plane VCN 318 and DB subnet(s) 330 contained in the data plane data tier 350. The data plane data tier 350 can include DB subnet(s) 330 that can be communicatively coupled to the service gateway 336 contained in the data plane VCN 318.

The untrusted app subnet(s) 362 can include one or more primary VNICs 364(1)-(N) that can be communicatively coupled to tenant virtual machines (VMs) 366(1)-(N). Tenant(s) VM 366(1)-(N) can be communicatively coupled to a respective app subnet 367(1)-(N) that can be contained in respective container egress VCNs 368(1)-(N) that can be contained in respective customer tenancies 380(1)-(N). Respective secondary VNICs 372(1)-(N) can facilitate communication between the untrusted app subnet(s) 362 contained in the data plane VCN 318 and the app subnet contained in the container egress VCNs 368(1)-(N). Container egress VCNs 368(1)-(N) can include a NAT gateway 338 that can be communicatively coupled to public Internet 354 (e.g., public Internet 154 of FIG. 1).

The Internet gateway 334 contained in the control plane VCN 316 and contained in the data plane VCN 318 can be communicatively coupled to a metadata management service 352 (e.g., the metadata management service 152 of FIG. 1) that can be communicatively coupled to public Internet 354. Public Internet 354 can be communicatively coupled to the NAT gateway 338 contained in the control plane VCN 316 and contained in the data plane VCN 318. The service gateway 336 contained in the control plane VCN 316 and contained in the data plane VCN 318 can be communicatively couple to cloud services 356.

In some embodiments, the data plane VCN 318 can be integrated with customer tenancies 380. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether or not to run code given to the IaaS provider by the customer.

In some examples, the customer of the IaaS provider may grant temporary network access to the IaaS provider and request a function to be attached to the data plane app tier 346. Code to run the function may be executed in the VMs 366(1)-(N), and the code may not be configured to run anywhere else on the data plane VCN 318. VM 366(1)-(N) may be connected to one customer tenancy 380. Respective containers 381(1)-(N) contained in the VMs 366(1)-(N) may be configured to run the code. In this case, there can be a dual isolation (e.g., the containers 381(1)-(N) running code), where the containers 381(1)-(N) may be contained in at least the VM 366(1)-(N) that are contained in the untrusted app subnet(s) 362) that may help prevent incorrect or otherwise undesirable code from damaging the network of the IaaS provider or from damaging a network of a different customer. The containers 381(1)-(N) may be communicatively coupled to the customer tenancy 380 and may be configured to transmit or receive data from the customer tenancy 380. The containers 381(1)-(N) may not be configured to transmit or receive data from any other entity in the data plane VCN 318. Upon completion of running the code, the IaaS provider may kill or otherwise dispose of the containers 381(1)-(N).

In some embodiments, the trusted app subnet(s) 360 may run code that may be owned or operated by the IaaS provider. In this embodiment, the trusted app subnet(s) 360 may be communicatively coupled to the DB subnet(s) 330 and be configured to execute CRUD operations in the DB subnet(s) 330. The untrusted app subnet(s) 362 may be communicatively coupled to the DB subnet(s) 330, but in this embodiment, the untrusted app subnet(s) may be configured to execute read operations in the DB subnet(s) 330. The containers 381(1)-(N) that can be contained in the VM 366(1)-(N) of the customer and that may run code from the customer may not be communicatively coupled with the DB subnet(s) 330.

In other embodiments, the control plane VCN 316 and the data plane VCN 318 may not be directly communicatively coupled. In this embodiment, there may be no direct communication between the control plane VCN 316 and the data plane VCN 318. However, communication can occur indirectly through at least one method. An LPG 310 may be established by the IaaS provider that can facilitate communication between the control plane VCN 316 and the data plane VCN 318. In another example, the control plane VCN 316 or the data plane VCN 318 can make a call to cloud services 356 via the service gateway 336. For example, a call to cloud services 356 from the control plane VCN 316 can include a request for a service that can communicate with the data plane VCN 318.

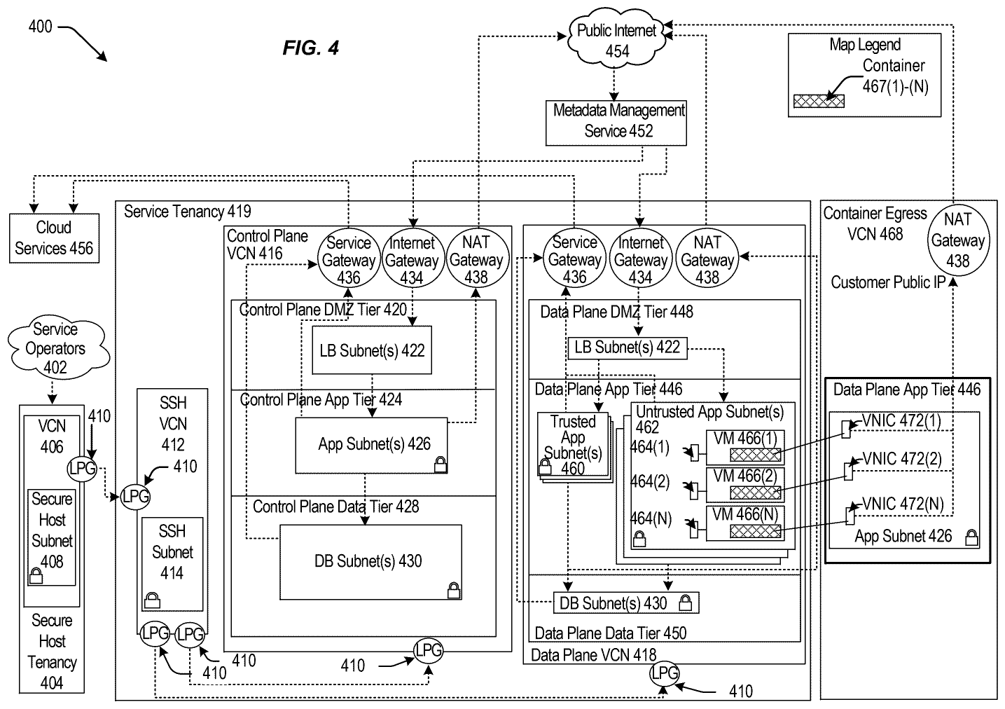

FIG. 4 is a block diagram illustrating another example pattern of an IaaS architecture 400 according to at least one embodiment. Service operators 402 (e.g., service operators 102 of FIG. 1) can be communicatively coupled to a secure host tenancy 404 (e.g., the secure host tenancy 104 of FIG. 1) that can include a virtual cloud network (VCN) 406 (e.g., the VCN 106 of FIG. 1) and a secure host subnet 408 (e.g., the secure host subnet 108 of FIG. 1). The VCN 406 can include an LPG 410 (e.g., the LPG 110 of FIG. 1) that can be communicatively coupled to an SSH VCN 412 (e.g., the SSH VCN 112 of FIG. 1) via an LPG 410 contained in the SSH VCN 412. The SSH VCN 412 can include an SSH subnet 414 (e.g., the SSH subnet 114 of FIG. 1), and the SSH VCN 412 can be communicatively coupled to a control plane VCN 416 (e.g., the control plane VCN 116 of FIG. 1) via an LPG 410 contained in the control plane VCN 416 and to a data plane VCN 418 (e.g., the data plane VCN 118 of FIG. 1) via an LPG 410 contained in the data plane VCN 418. The control plane VCN 416 and the data plane VCN 418 can be contained in a service tenancy 419 (e.g., the service tenancy 119 of FIG. 1).

The control plane VCN 416 can include a control plane DMZ tier 420 (e.g., the control plane DMZ tier 120 of FIG. 1) that can include LB subnet(s) 422 (e.g., LB subnet(s) 122 of FIG. 1), a control plane app tier 424 (e.g., the control plane app tier 124 of FIG. 1) that can include app subnet(s) 426 (e.g., app subnet(s) 126 of FIG. 1), and a control plane data tier 428 (e.g., the control plane data tier 128 of FIG. 1) that can include DB subnet(s) 430 (e.g., DB subnet(s) 330 of FIG. 3). The LB subnet(s) 422 contained in the control plane DMZ tier 420 can be communicatively coupled to the app subnet(s) 426 contained in the control plane app tier 424 and to an Internet gateway 434 (e.g., the Internet gateway 134 of FIG. 1) that can be contained in the control plane VCN 416, and the app subnet(s) 426 can be communicatively coupled to the DB subnet(s) 430 contained in the control plane data tier 428 and to a service gateway 436 (e.g., the service gateway of FIG. 1) and a network address translation (NAT) gateway 438 (e.g., the NAT gateway 138 of FIG. 1). The control plane VCN 416 can include the service gateway 436 and the NAT gateway 438.

The data plane VCN 418 can include a data plane app tier 446 (e.g., the data plane app tier 146 of FIG. 1), a data plane DMZ tier 448 (e.g., the data plane DMZ tier 148 of FIG. 1), and a data plane data tier 450 (e.g., the data plane data tier 150 of FIG. 1). The data plane DMZ tier 448 can include LB subnet(s) 422 that can be communicatively coupled to trusted app subnet(s) 460 (e.g., trusted app subnet(s) 360 of FIG. 3) and untrusted app subnet(s) 462 (e.g., untrusted app subnet(s) 362 of FIG. 3) of the data plane app tier 446 and the Internet gateway 434 contained in the data plane VCN 418. The trusted app subnet(s) 460 can be communicatively coupled to the service gateway 436 contained in the data plane VCN 418, the NAT gateway 438 contained in the data plane VCN 418, and DB subnet(s) 430 contained in the data plane data tier 450. The untrusted app subnet(s) 462 can be communicatively coupled to the service gateway 436 contained in the data plane VCN 418 and DB subnet(s) 430 contained in the data plane data tier 450. The data plane data tier 450 can include DB subnet(s) 430 that can be communicatively coupled to the service gateway 436 contained in the data plane VCN 418.

The untrusted app subnet(s) 462 can include primary VNICs 464(1)-(N) that can be communicatively coupled to tenant virtual machines (VMs) 466(1)-(N) residing within the untrusted app subnet(s) 462. Tenant VM 466(1)-(N) can run code in a respective container 467(1)-(N) and be communicatively coupled to an app subnet 426 that can be contained in a data plane app tier 446 that can be contained in a container egress VCN 468. Respective secondary VNICs 472(1)-(N) can facilitate communication between the untrusted app subnet(s) 462 contained in the data plane VCN 418 and the app subnet contained in the container egress VCN 468. The container egress VCN can include a NAT gateway 438 that can be communicatively coupled to public Internet 454 (e.g., public Internet 154 of FIG. 1).

The Internet gateway 434 contained in the control plane VCN 416 and contained in the data plane VCN 418 can be communicatively coupled to a metadata management service 452 (e.g., the metadata management service 152 of FIG. 1) that can be communicatively coupled to public Internet 454. Public Internet 454 can be communicatively coupled to the NAT gateway 438 contained in the control plane VCN 416 and contained in the data plane VCN 418. The service gateway 436 contained in the control plane VCN 416 and contained in the data plane VCN 418 can be communicatively couple to cloud services 456.

In some examples, the pattern illustrated by the architecture of block diagram 400 of FIG. 4 may be considered an exception to the pattern illustrated by the architecture of block diagram 300 of FIG. 3 and may be desirable for a customer of the IaaS provider if the IaaS provider cannot directly communicate with the customer (e.g., a disconnected region). The respective containers 467(1)-(N) that are contained in the VMs 466(1)-(N) for customers can be accessed in real-time by the customer. The containers 467(1)-(N) may be configured to make calls to respective secondary VNICs 472(1)-(N) contained in app subnet(s) 426 of the data plane app tier 446 that can be contained in the container egress VCN 468. The secondary VNICs 472(1)-(N) can transmit the calls to the NAT gateway 438 that may transmit the calls to public Internet 454. In this example, the containers 467(1)-(N) that can be accessed in real time by the customer can be isolated from the control plane VCN 416 and can be isolated from other entities contained in the data plane VCN 418. The containers 467(1)-(N) may also be isolated from resources from other customers.

In other examples, the customer can use the containers 467(1)-(N) to call cloud services 456. In this example, the customer may run code in the containers 467(1)-(N) that request a service from cloud services 456. The containers 467(1)-(N) can transmit this request to the secondary VNICs 472(1)-(N) that can transmit the request to the NAT gateway that can transmit the request to public Internet 454. Public Internet 454 can transmit the request to LB subnet(s) 422 contained in the control plane VCN 416 via the Internet gateway 434. In response to determining the request is valid, the LB subnet(s) can transmit the request to app subnet(s) 426 that can transmit the request to cloud services 456 via the service gateway 436.

It should be appreciated that IaaS architectures 100, 200, 300, and 400 may include components that are different and/or additional to the components shown in the figures. Further, the embodiments shown in the figures represent non-exhaustive examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

In one or more embodiments, a computer network provides connectivity among a set of nodes. The nodes may be local to and/or remote from one other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as execution of a particular application and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally, or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network such as a physical network. A node in an overlay network corresponds to a respective node in the underlying network. Hence, a node in an overlay network is associated with both an overlay address (to address to the overlay node) and an underlay address (to address the underlay node that implements the overlay node). An overlay node may be a digital device and/or a software process, such as a virtual machine, an application instance, or a thread. A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of one another. Network resources are dynamically assigned to the requests and/or clients on an on-demand basis. Network resources assigned to a request and/or client may be scaled up or down based on one or more of the following: (a) the computing services requested by a particular client, (b) the aggregated computing services requested by a particular tenant, or (c) the aggregated computing services requested of the computer network. Such a computer network may be referred to as a “cloud network.”

In an embodiment, a service provider provides a cloud network to one or more end users. Various service models may be implemented by the cloud network, including, but not limited, to Software-as-a-Service (SaaS), Platform-as-a-Service (PaaS), and Infrastructure-as-a-Service (IaaS). In SaaS, a service provider provides end users the capability to use the service provider's applications that are executing on the network resources. In PaaS, the service provider provides end users the capability to deploy custom applications onto the network resources. The custom applications may be created using programming languages, libraries, services, and tools supported by the service provider. In IaaS, the service provider provides end users the capability to provision processing, storage, networks, and other fundamental computing resources provided by the network resources. Any arbitrary applications, including an operating system, may be deployed on the network resources.

In an embodiment, various deployment models may be implemented by a computer network, including, but not limited to, a private cloud, a public cloud, and a hybrid cloud. In a private cloud, network resources are provisioned for exclusive use by a particular group of one or more entities; the term “entity” as used herein refers to a corporation, organization, person, or other entity. The network resources may be local to and/or remote from the premises of the particular group of entities. In a public cloud, cloud resources are provisioned for multiple entities that are independent from one another (also referred to as “tenants” or “customers”). The computer network and the network resources thereof are accessed by clients corresponding to different tenants. Such a computer network may be referred to as a “multi-tenant computer network.” Several tenants may use a same particular network resource at different times and/or at the same time. The network resources may be local to and/or remote from the premises of the tenants. In a hybrid cloud, a computer network comprises a private cloud and a public cloud. An interface between the private cloud and the public cloud allows for data and application portability. Data stored at the private cloud and data stored at the public cloud may be exchanged through the interface. Applications implemented at the private cloud and applications implemented at the public cloud may have dependencies on one other. A call from an application at the private cloud to an application at the public cloud (and vice versa) may be executed through the interface.

In an embodiment, tenants of a multi-tenant computer network are independent of one another. For example, a business or operation of one tenant may be separate from a business or operation of another tenant. Different tenants may demand different network requirements for the computer network. Examples of network requirements include processing speed, amount of data storage, security requirements, performance requirements, throughput requirements, latency requirements, resiliency requirements, Quality of Service (QOS) requirements, tenant isolation, and/or consistency. The same computer network may need to implement different network requirements demanded by different tenants.

In one or more embodiments, in a multi-tenant computer network, tenant isolation is implemented to ensure that the applications and/or data of different tenants are not shared with other tenants. Various tenant isolation approaches may be used.

In an embodiment, a tenant is associated with a tenant ID. The network resource of the multi-tenant computer network is tagged with a tenant ID. A tenant is permitted access to a particular network resource when the tenant and the particular network resources are associated with a same tenant ID.

In an embodiment, a tenant is associated with a tenant ID. An application, implemented by the computer network, is tagged with a tenant ID. Additionally, or alternatively, data structures and/or datasets, stored by the computer network, are tagged with a tenant ID. A tenant is permitted access to a particular application, data structure, and/or dataset when the tenant and the particular application, data structure, and/or dataset are associated with a same tenant ID.

As an example, a database implemented by a multi-tenant computer network may be tagged with a tenant ID. A tenant associated with the corresponding tenant ID may access data of a particular database. As another example, an entry in a database implemented by a multi-tenant computer network may be tagged with a tenant ID. A tenant associated with the corresponding tenant ID may access data of a particular entry. However, multiple tenants may share the database.

In an embodiment, a subscription list identifies a set of tenants, and, for a particular tenant, a set of applications that the particular tenant is authorized to access. For a particular application, a list of tenant IDs of tenants authorized to access the particular application is stored. A tenant is permitted access to a particular application when the tenant ID of the tenant is included in the subscription list corresponding to the particular application.

In an embodiment, network resources (such as digital devices, virtual machines, application instances, and threads) corresponding to different tenants are isolated to tenant-specific overlay networks maintained by the multi-tenant computer network. As an example, packets from any source device in a tenant overlay network may be transmitted to other devices within the same tenant overlay network. Encapsulation tunnels are used to prohibit any transmissions from a source device on a tenant overlay network to devices in other tenant overlay networks. Specifically, the packets received from the source device are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

### 3. COMPUTER SYSTEM

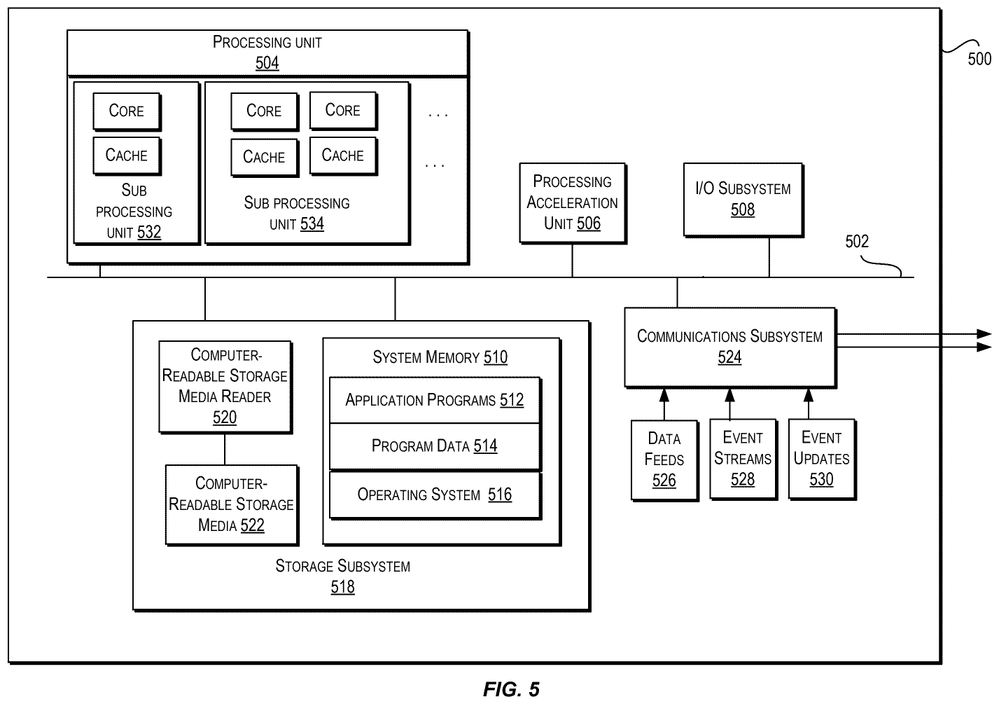

FIG. 5 illustrates an example computer system 500. An embodiment of the disclosure may be implemented upon the computer system 500. As shown in FIG. 5, computer system 500 includes a processing unit 504 that communicates with peripheral subsystems via a bus subsystem 502. These peripheral subsystems may include a processing acceleration unit 506, an I/O subsystem 508, a storage subsystem 518, and a communications subsystem 524. Storage subsystem 518 includes tangible computer-readable storage media 522 and a system memory 510.

Bus subsystem 502 provides a mechanism for letting the various components and subsystems of computer system 500 to communicate with one another as intended. Although bus subsystem 502 is shown schematically as a single bus, alternative embodiments of the bus subsystem may utilize multiple buses. Bus subsystem 502 may be any of several types of bus structures, including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus. Additionally, such architectures may be implemented as a Mezzanine bus manufactured to the IEEE P1386.1 standard.

Processing unit 504 controls the operation of computer system 500. Processing unit 504 can be implemented as one or more integrated circuits (e.g., a conventional microprocessor or microcontroller). One or more processors may be included in processing unit 504. These processors may include single core or multicore processors. In certain embodiments, processing unit 504 may be implemented as one or more independent processing units 532 and/or 534 with single or multicore processors included in the processing unit. In other embodiments, processing unit 504 may also be implemented as a quad-core processing unit formed by integrating two dual-core processors into a single chip.

In various embodiments, processing unit 504 can execute a variety of programs in response to program code and can maintain multiple concurrently executing programs or processes. At any given time, the program code to be executed can be wholly or partially resident in processing unit 504 and/or in storage subsystem 518. Through suitable programming, processing unit 504 can provide various functionalities described above. Computer system 500 may additionally include a processing acceleration unit 506 that can include a digital signal processor (DSP), a special-purpose processor, and/or the like.

I/O subsystem 508 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include medical imaging input devices such as computed tomography, magnetic resonance imaging, position emission tomography, or medical ultrasonography devices. User interface input devices may also include audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include any type of device and mechanism for outputting information from computer system 500 to a user or other computer. For example, user interface output devices may include, without limitation, a variety of display devices that visually convey text, graphics and audio/video information, such as monitors, printers, speakers, headphones, automotive navigation systems, plotters, voice output devices, and modems.

Computer system 500 may comprise a storage subsystem 518 that provides a tangible non-transitory computer-readable storage medium for storing software and data constructs that provide the functionality of the embodiments described in this disclosure. The software can include programs, code modules, instructions, scripts, etc., that when executed by one or more cores or processors of processing unit 504 provide the functionality described above. Storage subsystem 518 may also provide a repository for storing data used in accordance with the present disclosure.

As depicted in the example in FIG. 5, storage subsystem 518 can include various components, including a system memory 510, computer-readable storage media 522, and a computer readable storage media reader 520. System memory 510 may store program instructions, such as application programs 512, that are loadable and executable by processing unit 504. System memory 510 may also store data, such as program data 514, that is used during the execution of the instructions and/or data that is generated during the execution of the program instructions. Various programs may be loaded into system memory 510 including, but not limited to, client applications, Web browsers, mid-tier applications, relational database management systems (RDBMS), virtual machines, containers, etc.

System memory 510 may also store an operating system 516. Examples of operating system 516 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems. In certain implementations where computer system 500 executes one or more virtual machines, the virtual machines along with their guest operating systems (GOSs) may be loaded into system memory 510 and executed by one or more processors or cores of processing unit 504.

System memory 510 can come in different configurations depending upon the type of computer system 500. For example, system memory 510 may be volatile memory (such as random access memory (RAM)) and/or non-volatile memory (such as read-only memory (ROM), flash memory, etc.). Different types of RAM configurations may be provided, including a static random access memory (SRAM), a dynamic random access memory (DRAM), and others. In some implementations, system memory 510 may include a basic input/output system (BIOS) containing basic routines that help to transfer information between elements within computer system 500 such as during start-up.

Computer-readable storage media 522 may represent remote, local, fixed, and/or removable storage devices plus storage media for temporarily and/or more permanently containing, storing, computer-readable information for use by computer system 500, including instructions executable by processing unit 504 of computer system 500.

Computer-readable storage media 522 can include any appropriate media known or used in the art, including storage media and communication media, such as but not limited to volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media.

By way of example, computer-readable storage media 522 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 522 may include, but is not limited to, Zip® drives, flash memory cards, universal serial bus (USB) flash drives, secure digital (SD) cards, DVD disks, digital video tape, and the like. Computer-readable storage media 522 may also include solid-state drives (SSD) based on non-volatile memory, such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 500.

Machine-readable instructions executable by one or more processors or cores of processing unit 504 may be stored on a non-transitory computer-readable storage medium. A non-transitory computer-readable storage medium can include physically tangible memory or storage devices that include volatile memory storage devices and/or non-volatile storage devices. Examples of non-transitory computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 524 provides an interface to other computer systems and networks. Communications subsystem 524 serves as an interface for receiving data from and transmitting data to other systems from computer system 500. For example, communications subsystem 524 may enable computer system 500 to connect to one or more devices via the Internet. In some embodiments, communications subsystem 524 can include radio frequency (RF) transceiver components to access wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components. In some embodiments, communications subsystem 524 can provide wired network connectivity (e.g., Ethernet) in addition to or instead of a wireless interface.

In some embodiments, communications subsystem 524 may also receive input communication in the form of structured and/or unstructured data feeds 526, event streams 528, event updates 530, and the like on behalf of one or more users who may use computer system 500.

By way of example, communications subsystem 524 may be configured to receive data feeds 526 in real-time from users of social networks and/or other communication services, such as Twitter® feeds, Facebook® updates, web feeds such as Rich Site Summary (RSS) feeds, and/or real-time updates from one or more third party information sources.

Additionally, communications subsystem 524 may be configured to receive data in the form of continuous data streams. The continuous data streams may include event streams 528 of real-time events and/or event updates 530 that may be continuous or unbounded in nature with no explicit end. Examples of applications that generate continuous data may include sensor data applications, financial tickers, network performance measuring tools (e.g., network monitoring and traffic management applications), clickstream analysis tools, automobile traffic monitoring, and the like.

Communications subsystem 524 may also be configured to output the structured and/or unstructured data feeds 526, event streams 528, event updates 530, and the like to one or more databases that may be in communication with one or more streaming data source computers coupled to computer system 500.

Computer system 500 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 500 depicted in FIG. 5 is intended as a non-limiting example. Many other configurations having more or fewer components than the system depicted in FIG. 5 are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

### 4. SYSTEM ARCHITECTURE FOR ORCHESTRATING EXECUTION OF RESOURCE MODIFICATION OPERATIONS

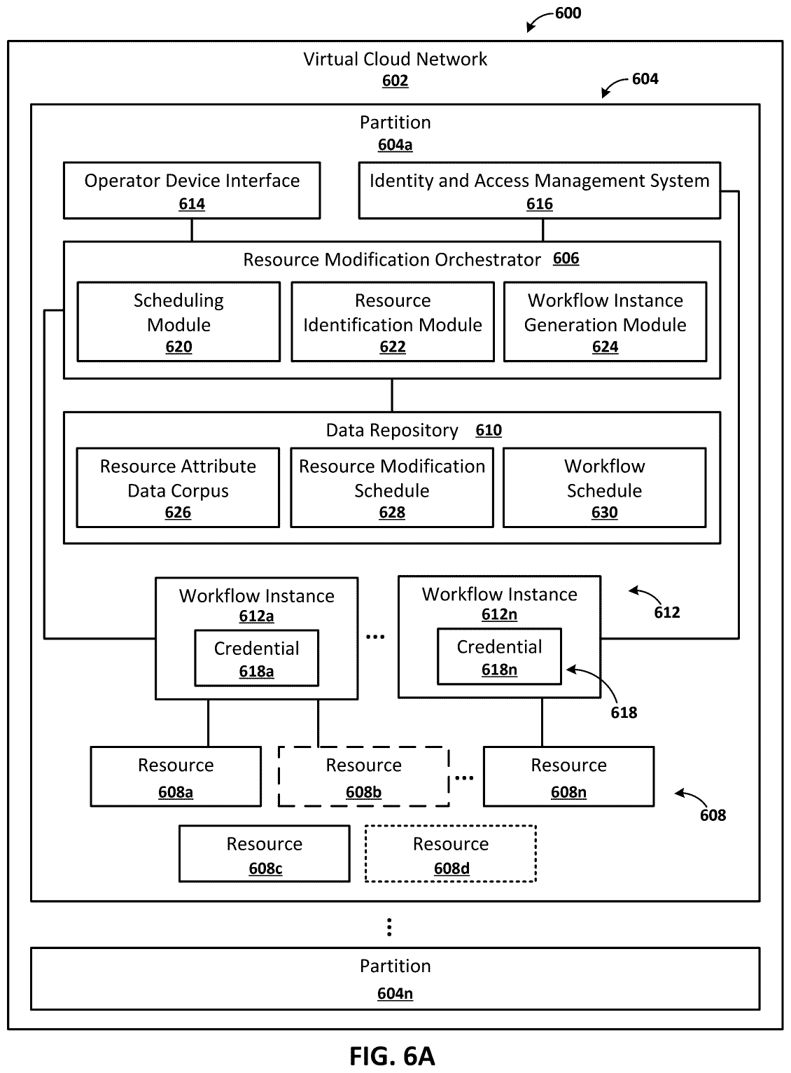

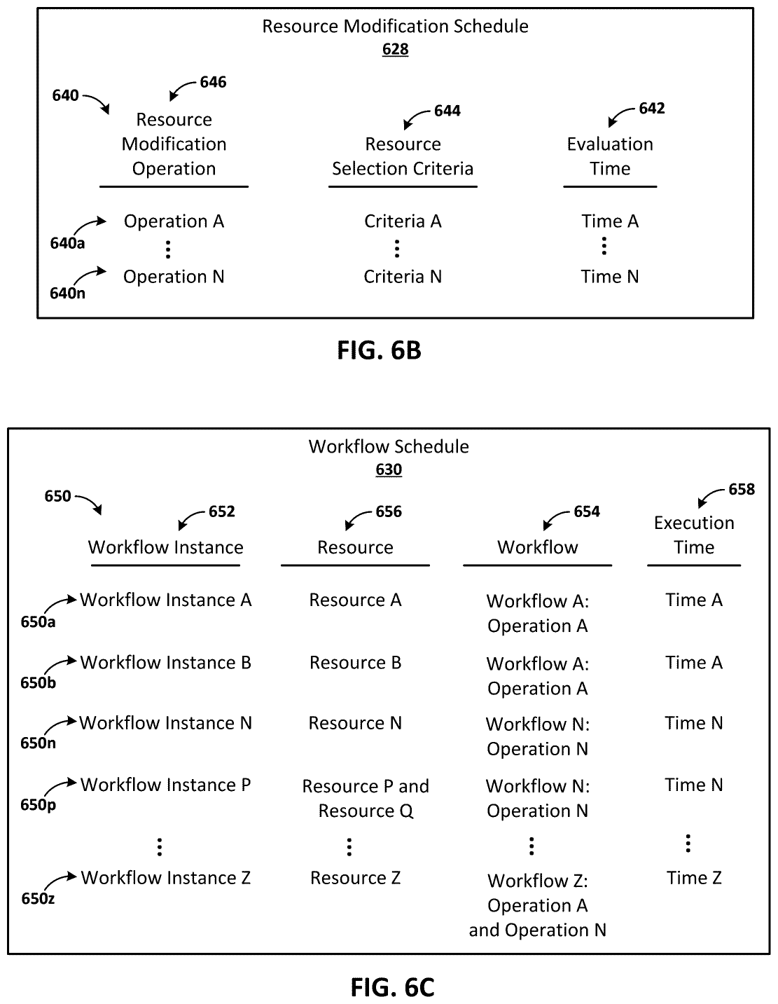

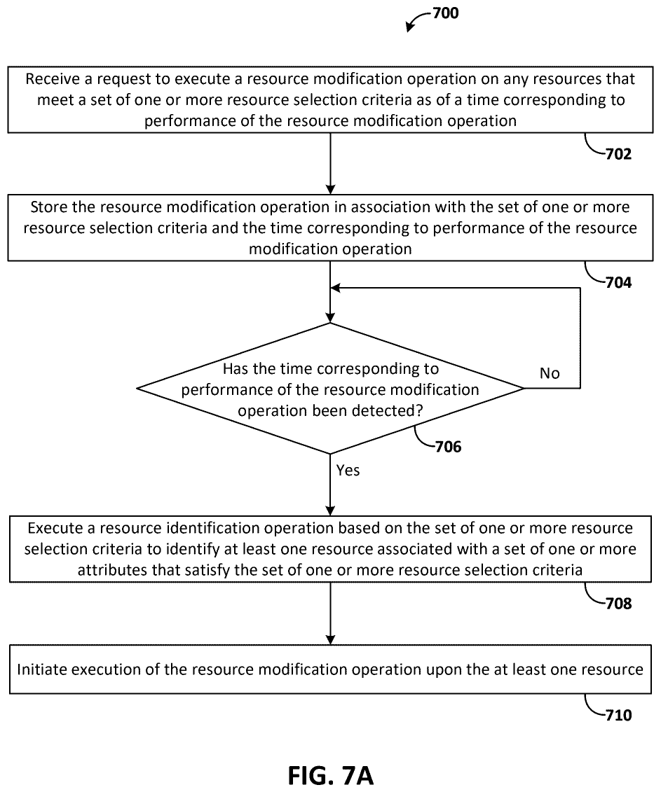

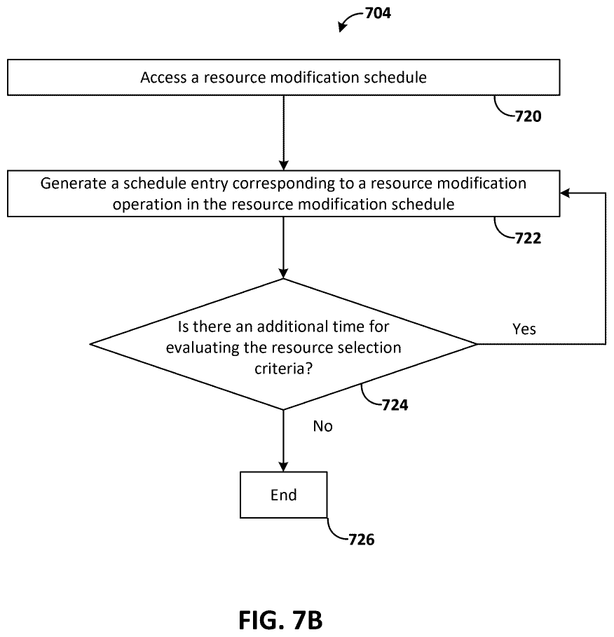

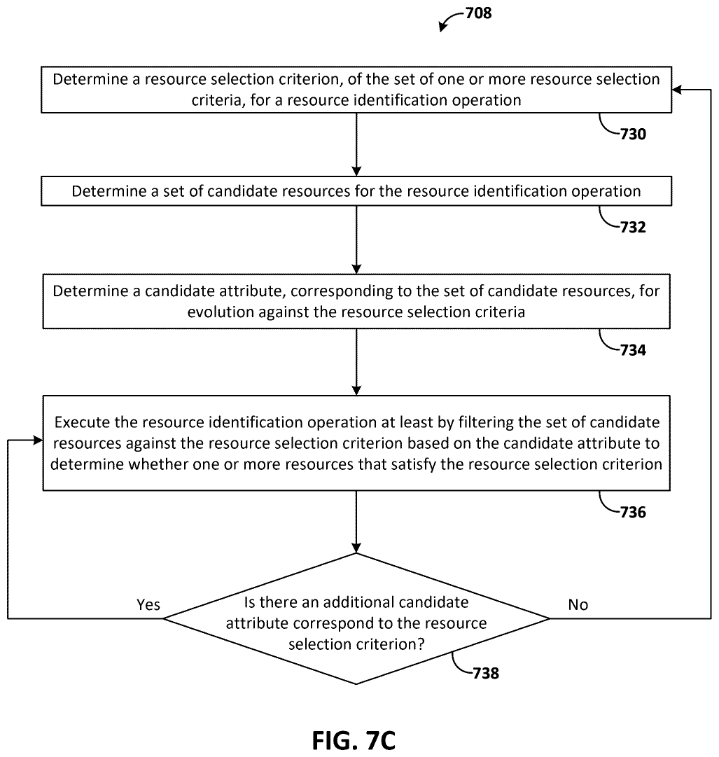

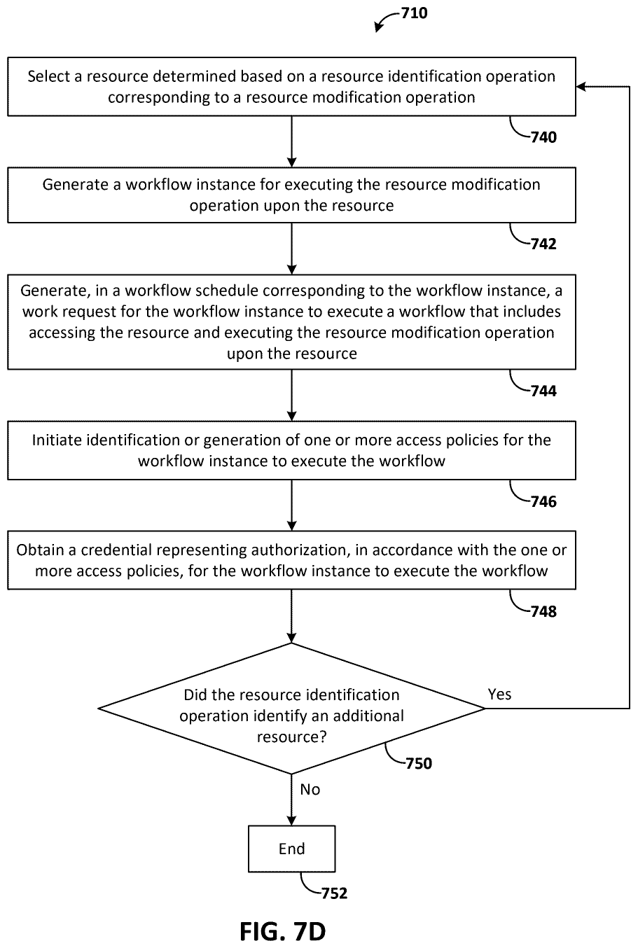

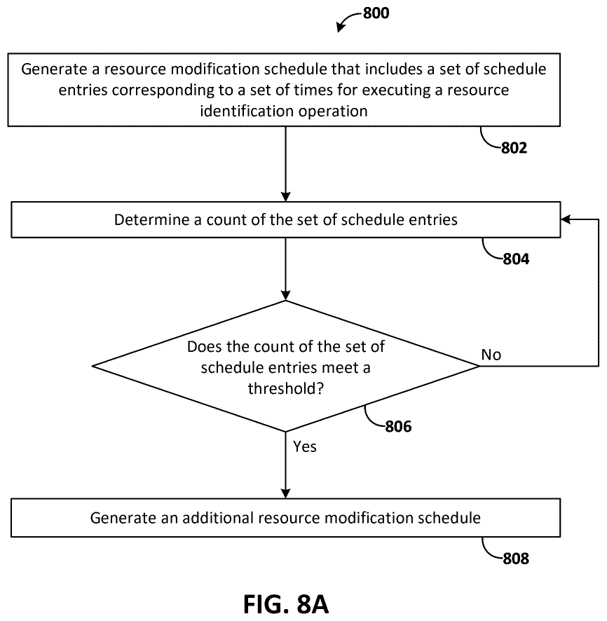

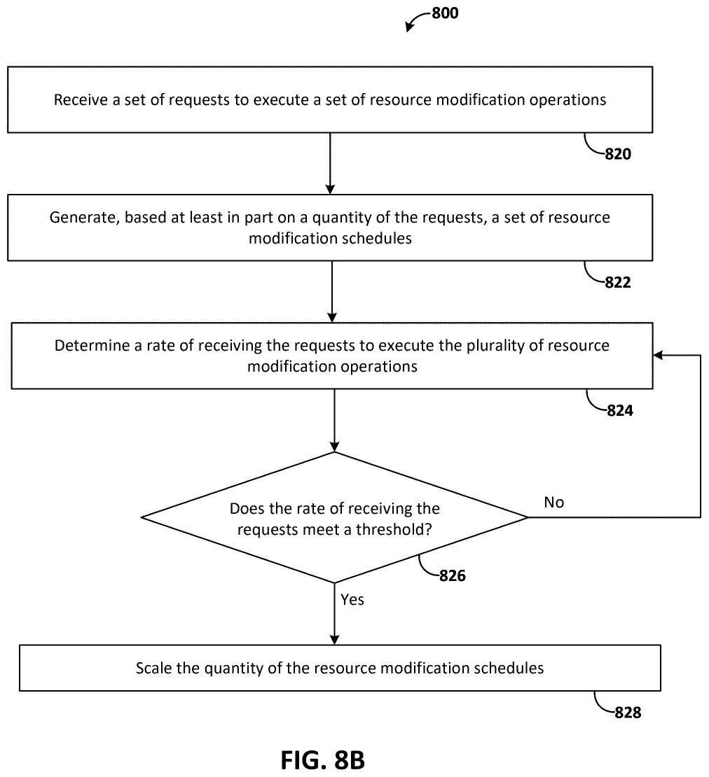

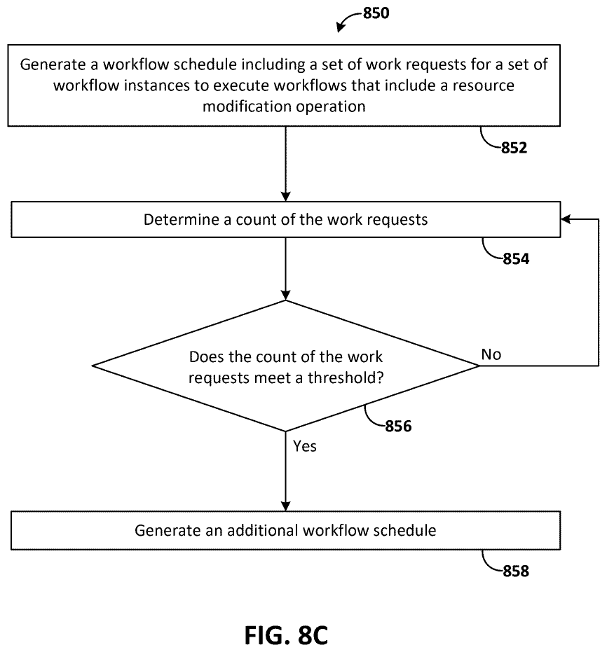

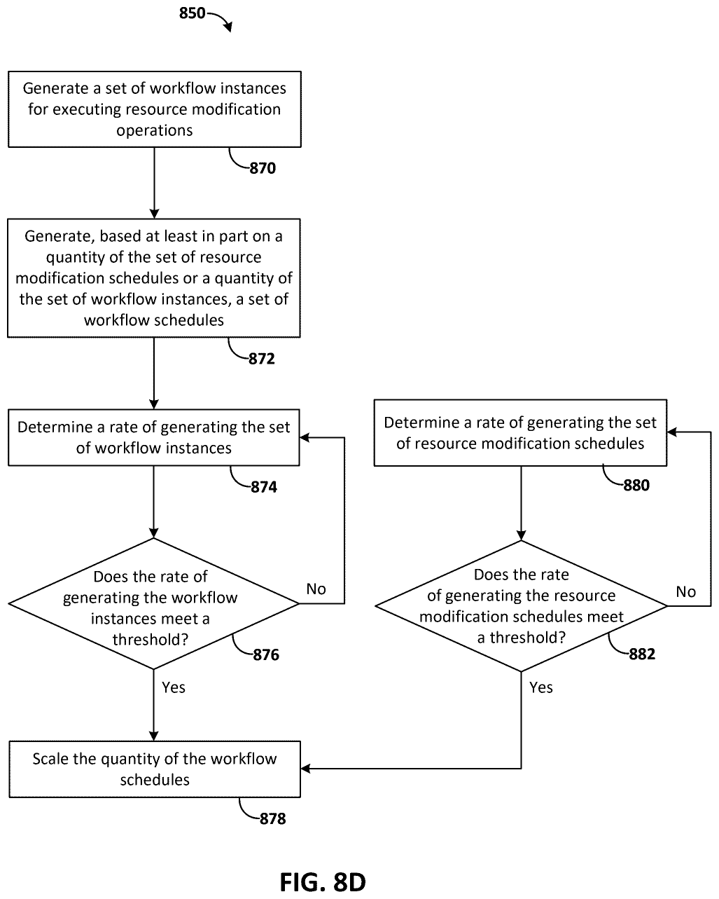

FIGS. 6A-6C illustrate features of an example system 600 in accordance with one or more embodiments. In one or more embodiments, the system 600 refers to hardware and/or software configured to perform operations described herein, including orchestrating execution of resource modification operations. Examples of operations are described below with reference to FIGS. 7A-7D and FIGS. 8A-8D. In addition to the features described with reference to FIGS. 6A-6C, the system 600 may include one or more features described above in Section 2, titled “Cloud Computing Technology,” and/or in Section 3, titled “Computer System.”

In one or more embodiments, the system 600 may include more or fewer components than the components described with reference to FIGS. 6A-6C. The components described with reference to FIGS. 6A-6C may be local to or remote from each other. The components described with reference to FIGS. 6A-6C may be implemented in software and/or hardware. The components of system 600 may be distributed over multiple applications and/or machines. Multiple components may be combined into one application and/or machine. Operations described with respect to one component may instead be performed by another component.

As shown in FIG. 6A, the system 600 includes a virtual cloud network 602. A set of partitions 604 are deployed on the virtual cloud network 602, such as partition 604a and partition 604n. The partitions 604 represent logically or physically isolated portions of the virtual cloud network 602. In one example, the partitions 604 include tenant partitions, or tenancies, that isolate portions of the virtual cloud network 602 between different entities, or tenants, such as cloud operators or customers. Additionally, or alternatively, the partitions 604 may include service partitions that isolate different services or workloads. Additionally, or alternatively, the partitions 604 may include geographic partitions that isolate a portion of the virtual cloud network 602 corresponding to a particular geographic region. Additionally, or alternatively, the partitions 604 may include network partitions that isolate the virtual cloud network 602 into separate segments or subnets.

Example features of the system 600 are further described with reference to partition 604a of the virtual cloud network 602. One or more other partitions 604 of the virtual cloud network 602 may also include all or a portion of the features described with reference to partition 604a. As shown with reference to partition 604a, the system 600 includes a resource modification orchestrator 606 for orchestrating execution of resource modification operations. The system 600 further includes a set of resources 608. The resource modification orchestrator 606 executes orchestration of resource modification operations on resources 608 that meet resource selection criteria. Further, the system 600 includes a data repository 610 for storing data associated with orchestrating execution of resource modification operations. Furthermore, the system 600 includes a set of workflow instances 612 for executing workflows that include accessing resources 608 and executing resource modification operations upon the resources 608. In one example, the system 600 includes an operator device interface 614 for a cloud operator or a customer to interact with the resource modification orchestrator 606. In one example, the cloud operator or the customer may utilize the operator device interface 614 to provide inputs, such as requests to execute resource modification operations, to the resource modification orchestrator. Additionally, or alternatively, the operator device interface 614 may output information to the could operator or customer pertaining to resource modification operations. In one example, the system 600 includes an identity and access management (IAM) system 616 for managing access policies that provide a basis for granting credentials 618 to the workflow instances 612 for executing the workflows. In one example, one or more other partitions 604 of the virtual cloud network 602 include a resource modification orchestrator 606 and a data repository 610, for example, for execution resource modification operations on resources 608 located in other partitions 604 of the virtual cloud network 602.

### A. Example Resource Modification Orchestrator

In one example, the resource modification orchestrator includes at least one of the following: a scheduling module 620, a resource identification module 622, or a workflow instance generation module 624. The scheduling module 620 executes operations associated with generating schedules for orchestrating execution of resource modification operations. The resource identification module 622 executes operations associated with identifying resources that meet resource selection criteria for executing resource modification operations. The workflow instance generation module 624 executes operations associated with generating workflow instances for executing resource modification operations.

In one example, the data repository 610 includes at least one of the following: a resource attribute data corpus 626, a resource modification schedule 628, or a workflow schedule 630. Example features of a resource modification schedule 628 are described below with reference to FIG. 6B. Example features of a workflow schedule 630 are described below with reference to FIG. 6C.

In one example, the scheduling module 620 may generate a resource modification schedule 628 in response to a request to execute a resource modification operation. Additionally, or alternatively, the scheduling module 620 adds schedule entries to a resource modification schedule 628 in response to a request to execute a resource modification operation. In one example, the resource identification module 622 determines that a time for executing a resource modification operation is approaching and evaluates attributes of resources 608 against resource selection criteria to identify resources that meet the resource selection criteria corresponding to the resource modification operation. The resource identification module 622 may identify the resources that meet the resource selection criteria by executing a query or filter upon a set of candidate resources 608. The resource identification module 622 may execute the query or filter upon resource attributes associated with the candidate resources 608. The resource attributes may be stored in the resource attribute data corpus 626. Additionally, or alternatively, the resource attributes may be located in metadata associated with the resources 608 such as in tags associated with the resources 608. Based on the query or filter, the resource identification module 628 may identify a set of one or more resources 608 that meet the resource selection criteria for the resource modification operation. In one example, the scheduling module 620 may generate a workflow schedule 630 for the resource modification operation based on the set of one or more resources 608 that meet the resource selection criteria for the resource modification operation. Additionally, or alternatively, based on the set of one or more resources 608 that meet the resource selection criteria for the resource modification operation, the workflow instance generation module 624 may generate a set of workflow instances 612 for executing the resource modification operation on the set of one or more resources 608. The workflow schedule 630 may include work requests for the set of workflow instances 612 to execute the resource modification operation on the set of one or more resources 608.

As shown in FIG. 6A, the set of resources 608 includes resource 608a, resource 608b, resource 608c, resource 608d, and resource 608n. In one example, the resource identification module 622 determines, by evaluating attributes associated with at least some of the resources 608, that resource 608a and resource 608b meet a first set of one or more resource selection criteria corresponding to a first resource modification operation. Additionally, or alternatively, the resource identification module 622 may determine, by evaluating attributes associated with at least some of the resources 608, that resource 608c, resource 608d, and/or resource 608n do not meet the first set of resource selection criteria corresponding to the first resource modification operation. The determinations by the resource identification module 622 may be based at least in part on a schedule entry, corresponding to the first resource modification operation in the resource modification schedule 628. Based on the determination that resource 608a and resource 608b meet the first set of resource selection criteria corresponding to the first resource modification operation, the workflow schedule 630 generates workflow instance 612a for executing the first resource modification operation upon resource 608a and resource 608b. Additionally, or alternatively, the scheduling module 620 generates work requests in the workflow schedule 630 for workflow instance 612a to execute the first resource modification operation upon resource 608a and resource 608b.

In one example, resource 608b is provisioned after a time when the scheduling module 620 schedules the first resource modification operation and prior to a time when the resource identification module 622 evaluates the first set of resource selection criteria. The workflow instance generation module 624 generates workflow instance 612a, for executing the first resource modification operation upon resource 608b, based at least in part on resource 608b having been provisioned as of the time when the resource identification module 622 evaluates the first set of resource selection criteria corresponding to the first resource modification operation. Additionally, or alternatively, the scheduling module 620 generates a work request, for workflow instance 612a to execute the first resource modification operation upon resource 608b, based at least in part on resource 608b having been provisioned as of the time when the resource identification module 622 evaluates the first set of resource selection criteria corresponding to the first resource modification operation.

In one example, attributes associated with resource 608b do not satisfy the first set of resource selection criteria at a time when the scheduling module 620 schedules the first resource modification operation. Additionally, the attributes associated with resource 608b satisfy the first set of resource selection criteria at a time when the resource identification module 622 evaluates the first set of resource selection criteria. The workflow instance generation module 624 generates workflow instance 612a, for executing the first resource modification operation upon resource 608b, based at least in part on the attributes associated with resource 608b satisfying the first set of resource selection criteria as of the time when the resource identification module 622 evaluates the first set of resource selection criteria corresponding to the first resource modification operation. Additionally, or alternatively, the scheduling module 620 generates a work request for workflow instance 612a to execute the first resource modification operation upon resource 608b. The scheduling module 620 generates the work request based at least in part on the attributes associated with resource 608b satisfying the first set of resource selection criteria as of the time when the resource identification module 622 evaluates the first set of resource selection criteria corresponding to the first resource modification operation.

In one example, attributes associated with resource 608n satisfy the first set of resource selection criteria at a time when the scheduling module 620 schedules the first resource modification operation. Additionally, the attributes associated with resource 608n do not satisfy the first set of resource selection criteria at a time when the resource identification module 622 evaluates the first set of resource selection criteria. The workflow instance generation module 624 refrains from generating a workflow instance for executing the first resource modification operation upon resource 608n based at least in part on the first set of resource selection criteria being unmet by the attributes associated with resource 608n as of the time when the resource identification module 622 evaluates the first set of resource selection criteria corresponding to the first resource modification operation. Additionally, or alternatively, the scheduling module 620 refrains from generating a work request for executing the first resource modification operation upon resource 608n based at least in part on the first set of resource selection criteria being unmet by the attributes associated with resource 608n as of the time when the resource identification module 622 evaluates the first set of resource selection criteria corresponding to the first resource modification operation.

In one example, the resource identification module 622 determines, by evaluating attributes associated with at least some of the resources 608, that resource 608n meets a second set of one or more resource selection criteria corresponding to a second resource modification operation. Additionally, or alternatively, the resource identification module 622 may determine, by evaluating attributes associated with at least some of the resources 608, that resource 608a, resource 608b, resource 608c, and/or resource 608d do not meet the second set of resource selection criteria. The determinations by the resource identification module 622 may be based at least in part on a schedule entry, corresponding to the second resource modification operation, in the resource modification schedule 628. Based on the determination that resource 608n meets the second set of resource selection criteria corresponding to the second resource modification operation, the workflow schedule 630 generates workflow instance 612n for executing the second resource modification operation upon resource 608n. Additionally, or alternatively, the scheduling module 620 generates a work request in the workflow schedule 630 for workflow instance 612n to execute the second resource modification operation upon resource 608n.

In one example, the workflow instance generation module 624 obtains credential 618a for workflow instance 612a to execute the workflows with respect to resource 608a and resource 608b. The IAM system 616 may issue credential 618a based on a first set of one or more access policies associated with resource 608a and/or resource 608b. Additionally, or alternatively, the workflow instance generation module 624 obtains credential 618n for workflow instance 612n to execute the workflow with respect to resource 608n. The IAM system 616 may issue credential 618n based on a second set of one or more access policies associated with resource 608n.

In one example, the credentials 618 obtained by the workflow instance generation module 624, such as credential 618a and/or credential 618n, may include one or more delegate credentials that allow the workflow instance to access a resource 608 based on one or more access policies associated with the resource 608. The workflow instance generation module 624 may obtain a delegate credential through one or more operations described in U.S. patent application Ser. No. 18/529,558, titled “ISSUING DELEGATE CREDENTIALS FOR ACCESSING TARGET RESOURCES,” filed Dec. 5, 2023 (“the '558 application”), which is incorporated herein by reference. The delegate credentials obtained by the workflow instance generation module 624 may include one or more features described in the '558 application.

Additionally, or alternatively, the credentials 618 obtained by the workflow instance generation module 624, such as credential 618a and/or credential 618n, may include one or more surrogate tokens that are based on a principal token corresponding to a resource 608. The workflow instance generation module 624 may obtain a surrogate token through one or more operations described in U.S. patent application Ser. No. 18/410,231, titled “ISSUING SURROGATE CREDENTIALS FOR ACCESSING TARGET RESOURCES,” filed Jan. 11, 2024 (“the '231 application”), which is incorporated herein by reference. The surrogate tokens obtained by the workflow instance generation module 624 may include one or more features described in the '231 application.

### B. Example Resources, Resource Attributes, Resource Selection Criteria, and Resource Modification Operations

The resources 608 may include one or more of the following: an operating system, a cloud management platform, a security platform, a development tool, a compute instance, a virtual machine, a container, a serverless computing platform, an auto-scaling application, a storage platform, a database instance, a networking component, a security component, a monitoring component, a development component, a support component, a machine-learning component, an artificial intelligence component, an analytics component, an integration component, a service, or a service feature.

In one example, the resources 608 include hidden resources. A hidden resource may include a service component that is inaccessible and/or invisible to a customer. The hidden resource may be associated with a customer-facing component that is accessed based on a resource dependency between the service component and the customer-facing component. The system 600 may access hidden resources through one or more operations described in U.S. patent application Ser. No. 18/640,885, titled “DETERMINING APPROVAL WORKFLOWS FOR OBTAINING APPROVALS TO ACCESS RESOURCES,” filed Apr. 19, 2024 (“the '885 application”), which is incorporated herein by reference. Example hidden resources are further described in the '885 application. In one example, the resource modification orchestrator 606 orchestrates execution of resource modification operations upon hidden resources. Because the resource modification orchestrator 606 orchestrates execution of resource modification operations on resources 608 that meet applicable resource selection criteria as of a time when the resource selection criteria are evaluated, the resource modification orchestrator 606 can orchestrate execution of resource modification operations upon hidden resources that are invisible and/or inaccessible to the customer.

The attributes of a resource 608 that are evaluated against resource selection criteria may include one or more properties, characteristics, or operational parameters associated with a resource 608. In one example, the attributes of a resource 608 may include one or more of the following: a partition identifier, a partition type, a tenancy identifier, a tenancy type, a resource name, a resource description, a resource type, a lifecycle state, a creation date, a resource age, a tag type, a tag identifier, a tag value, a keyword, a user identifier, or a user that generated the particular candidate resource. Additionally, or alternatively, the attributes of a resource 608 may include operational parameters that pertain to a configuration, state, or performance of the resource 608. The operational attributes may include one or more of the following: CPU allocation, CPU utilization, memory size, memory utilization, storage capacity, network bandwidth, network throughput, IP address, operational status, health status, lifecycle status, or security settings.

The attributes of a resource 608 may be included in metadata associated with the resource. The metadata may be included in tags that associate metadata with resources. A tag may represent an instance of a key definition that is applied to a resource 608. A tag may include a tag namespace, a tag key, and a tag value. The tag namespace may represent a logical grouping or category that serves as a container for tag keys and tag values. The tag key may represent an identifier or a name utilized to refer to the tag. The tag value may represent the data or value associated with the tag key.

In one example, an access policy defines a set of permissions corresponding to a tag and/or a tag namespace, and the set of permissions applies to any resources 608 that are tagged with the tag and/or the tag namespace corresponding to the access policy. In one example, the access policy is applied to a tag namespace, and any resources 608 that have a tag that is contained within the tag namespace are included within the scope of the access policy. Additionally, or alternatively, an access policy may define a set of permissions corresponding to a subset of one or more tags and/or tag namespaces that satisfy a set of resource selection criteria. The resource selection criteria may correspond to a property of the tag and/or the tag namespace. Additionally, or alternatively, the resource selection criteria may correspond to a tag value associated with the tag and/or the tag namespace. The set of permissions may apply to any resources 608 that are tagged with a tag and/or a tag namespace that satisfies the set of resource selection criteria corresponding to the access policy. In one example, the IAM system 616 issues a credential 618 to execute a resource modification operation on a set of one or more resources 608 based on an access policy that defines a set of permissions corresponding to one or more tags and/or tag namespaces applied to the set of one or more resources 608. For example, the access policy may define a set of permissions corresponding to one or more tags and/or tag namespaces that satisfy a set of resource selection criteria. Because the access policy is based on the one or more tags and/or tag namespaces, the set of permissions applies to any resources 608 that are tagged with a tag and/or a tag namespace corresponding to the access policy. For example, the set of permissions may apply to any resources 608 that are tagged with a tag and/or a tag namespace that satisfies the set of resource selection criteria. Because the set of permissions defined by the access policy applies to any resources 608 that are tagged with a tag and/or a tag namespace corresponding to the access policy, the IAM system may issue one or more credentials 618 based on the access policy for one or more workflow instances 612 to execute a resource modification operation on any resource 608 that satisfies the resource selection criteria.

The resource selection criteria can include various types of logical or relational operations that can be applied to attributes of resources 608. The resource selection criteria may include exact match criteria, partial match criteria, value range criteria, presence criteria, absence criteria, logical operators, or wildcards. The resource selection criteria may include exact match criteria to identify resources that have an attribute with a value that matches a value specified by the resource selection criteria. The resource selection criteria may include partial match criteria to identify resources that have an attribute with a value that partially matches a value specified by the resource selection criteria. The resource selection criteria may include range criteria to identify resources that have an attribute with a value that falls within a range specified by the resource selection criteria. The resource selection criteria may include presence criteria to identify resources that have an attribute specified by the resource selection criteria, for example, without regard to the particular value of the attribute. The resource selection criteria may include absence criteria to identify resources that lack an attribute specified by the resource selection criteria. The resource selection criteria may include logical operators to identify resources that satisfy logical conditions. The logical operators may include AND, OR, and NOT. The resource selection criteria may include wildcards to identify resources that have an attribute with a value that partially matches a value specified by the resource selection criteria. The resource selection criteria may specify one or more properties of a tag, such as a tag namespace, a tag key, and/or a tag value.

The resource modification operations may include operations that modify a configuration of a resource 608. The modification of the configuration of the resource 608 may include a modification to a state or property of the resource 608. In one example, the resource modification operations may include at least one of the following: initiating execution of a resource, pausing execution of a resource, restarting a resource, resetting a resource, terminating a resource, enabling a resource, enabling a feature of a resource, disabling a resource, disabling a feature of a resource, scaling up a capacity of a resource, scaling down the capacity of a resource, backing-up a resource, updating a resource, upgrading a resource, downgrading a resource, monitoring a resource, inspecting a resource, configuring a resource, reconfiguring a resource, allocating a resource to a purpose, deallocating a resource from a purpose, authenticating a resource, granting a permission to a resource, or revoking a permission from a resource.

The resource modification operations may be associated with at least one time for executing the resource modification operation and/or for identifying resources that satisfy resource selection criteria. In one example, a resource modification operation may be executed at approximately a particular time. Additionally, or alternatively, a resource modification operation may be executed multiple times such as according to a recurring time interval. The recurring time intervals may follow a consistent pattern. Alternatively, the recurring time intervals may be intermittent or irregular. The recurring time intervals may be based on one or more of the following: a time of day, a day of week, a week of year, or a time period. The system may schedule execution of a resource modification operation on a momentary, hourly, daily, weekly, monthly, and/or annual basis. The resource modification operation may be executed at approximately the same time of day, the same day of week, the same day of month, the same day of year, and/or the same time period. In one example, the time of executing the resource modification operation may vary slightly based on minor delays or deviations from a schedule, for example, based on one or more of the following: system load, resource availability, prioritization operations, network latency, or clock drift.

### C. Example Operator Device Interface

Referring further to FIG. 6A, the system 600 includes at least one operator device interface 614. The operator device interface 614 may include hardware and/or software configured to facilitate interactions between an operator and the resource modification orchestrator 606 and/or other aspects of the system 600. An operator device interface 614 may render user interface elements and receive input via user interface elements. For example, the operator device interface 614 may display outputs generated by the resource modification orchestrator 606 and/or other aspects of the system 600. Additionally, or alternatively, the operator device interface 614 may be configured to receive inputs to the resource modification orchestrator 606 and/or other aspects of the system 600. Examples of interfaces include a GUI, a command line interface (CLI), a haptic interface, or a voice command interface. Examples of user interface elements include checkboxes, radio buttons, dropdown lists, list boxes, buttons, toggles, text fields, date and time selectors, command lines, sliders, pages, or forms. Any one or more of these interface or interface elements may be utilized by an operator device interface 614.

In one example, different components of an operator device interface 614 are specified in different languages. The behavior of user interface elements is specified in a dynamic programming language such as JavaScript. The content of user interface elements is specified in a markup language, such as hypertext markup language (HTML) or XML User Interface Language (XUL). The layout of user interface elements is specified in a style sheet language such as Cascading Style Sheets (CSS). Alternatively, the operator device interface 614 may be specified in one or more other languages, such as Java, C, or C++.

In one example, the operator device interface 614 may be implemented at least in part on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (NAT), a hardware load balancer, a mainframe, a television, a content receiver, a set-top box, a printer, a mobile handset, a smartphone, a personal digital assistant (PDA), a wireless receiver and/or transmitter, a base station, a communication management device, a router, a switch, a controller, an access point, and/or a browser device.

### D. Example Resource Modification Schedules and Workflow Schedules

Referring to FIG. 6B, features of a resource modification schedule 628 are further described. As shown in FIG. 6B, a resource modification schedule 628 includes a set of schedule entries 640. The schedule entries 640 include a set of evaluation times 642 that identify a set of resources that satisfy a set of resource selection criteria 644. Additionally, the schedule entries include a set of resource modification operations 646 to be applied on any resources that satisfy the set of resource selection criteria 344. In one example, the set of schedule entries includes a first schedule entry 640a and a second schedule entry 640n. The first schedule entry 640a indicates that a set of one or more resource selection criteria 644 (Criteria A) is to be evaluated at an evaluation time 642 (Time A), and that a resource modification operation 646 (Operation A) is to be applied to any resources that satisfy the set of one or more resource selection criteria 644 (Criteria A). The second schedule entry 640n indicates that a set of one or more resource selection criteria 644 (Criteria N) is to be evaluated at an evaluation time 642 (Time N), and that a resource modification operation 646 (Operation N) is to be applied to any resources that satisfy set of one or more resource selection criteria 644 (Criteria N).

Referring to FIG. 6C, features of a workflow schedule 630 are further described. As shown in FIG. 6C, a workflow schedule 630 includes a set of work requests 650 for a set of workflow instances 652 to execute a set of workflows 654 on a set of resources 656 at an execution time 658. The work requests 650 in the workflow schedule correspond to at least one schedule entry 640 in a resource modification schedule 628 (FIG. 6B). The workflows 654 in the work requests correspond to at least one resource modification operation 646 in the resource modification schedule 628 (FIG. 6B). The resources 656 identified in the work requests 650 satisfy the resource selection criteria 644 of the corresponding schedule entry 640 in the resource modification schedule 628 (FIG. 6B). The execution times 658 of the work requests 650 may correspond to an evaluation time 642 of the corresponding schedule entry 640 in the resource modification schedule 628 (FIG. 6B). In one example, the execution times 658 of the work requests 650 match the evaluation time 642 of the corresponding schedule entry 640. In one example, the execution times 658 of the work requests 650 are offset from the evaluation time 642 of the corresponding schedule entry 640. The offset may account for delay, for example, associated with on one or more of the following: system load, resource availability, prioritization operations, or network latency.

In one example, the work requests 650 include work request 650a, work request 650b, and work request 650n. Work request 650a and work request 650b correspond to schedule entry 640a (FIG. 6B). Work request 650a indicates that a workflow instance 652 (Workflow Instance A) is to execute a workflow 654 (Workflow A) that includes accessing a resource 656 (Resource A) that satisfies a set of resource selection criteria 644 (FIG. 6B) and executing a resource modification operation 646 (Operation A) on the resource 656 (Resource A) at an execution time 658 (Time A). Work request 650b indicates that a workflow instance 652 (Workflow Instance B) is to execute a workflow 654 (Workflow B) that includes accessing a resource 656 (Resource B) that satisfies a set of resource selection criteria 644 (FIG. 6B) and executing a resource modification operation 646 (Operation B) on the resource 656 (Resource B) at an execution time 658 (Time B). The resources 656 corresponding to work request 650a and work request 650b satisfy the resource selection criteria 644 (Criteria A) of schedule entry 640a (FIG. 6B). Work request 650n corresponds to schedule entry 640n (FIG. 6B). Work request 650n indicates that a workflow instance 652 (Workflow Instance N) is to execute a workflow 654 (Workflow N) that includes accessing a resource 656 (Resource N) that satisfies a set of resource selection criteria 644 (FIG. 6B) and executing a resource modification operation 646 (Operation N) on the resource 656 (Resource N) at an execution time 658 (Time N). The resource 656 corresponding to work request 650n satisfies the resource selection criteria 644 (Criteria N) of schedule entry 640n (FIG. 6B).

In one example, a work request 650 may provide for a workflow instance 652 to execute a workflow 654 upon multiple resources 656. For example, as shown in FIG. 6C, the work requests 650 include work request 650p. Work request 650p corresponds to schedule entry 640n (FIG. 6B). Work request 650p indicates that a workflow instance 652 (Workflow Instance P) is to execute a workflow 654 (Workflow N) that includes accessing a set of resources 656 (Resource P and Resource Q) that satisfy a set of resource selection criteria 644 (FIG. 6B) and executing a resource modification operation 646 (Operation N) on the resources 656 (Resource P and Resource Q) at an execution time 658 (Time N). The resources 656 corresponding to work request 650n satisfy the resource selection criteria 644 (Criteria N) of schedule entry 640n (FIG. 6B).

In one example, a work request 650 may provide for a workflow instance 652 to execute a workflow 654 that includes multiple resources modification operations 646 (FIG. 6B). For example, as shown in FIG. 6C, the work requests 650 include work request 650z. Work request 650z corresponds to schedule entry 640a and schedule entry 640n (FIG. 6B). Work request 650z indicates that a workflow instance 652 (Workflow Instance Z) is to execute a workflow 654 (Workflow Z) that includes accessing a resource 656 (Resource Z) that satisfies a set of resource selection criteria 644 (FIG. 6B) and executing a set of resource modification operations 646 (Operation A and Operation N) on the resource 656 (Resource Z) at an execution time 658 (Time Z). The resource 656 corresponding to work request 650n satisfies the resource selection criteria 644 (Criteria A) of schedule entry 640a and the resource selection criteria 644 (Criteria N) of schedule entry 640n (FIG. 6B).

Referring again to FIG. 6A, one or more resource modification schedules 628 and/or one or more workflow schedules 630 may be stored in a data repository 610. In one or more embodiments, the data repository 610 is any type of storage unit and/or device (e.g., a file system, database, collection of tables, or any other storage mechanism) for storing data. Furthermore, the data repository 610 may include multiple different storage units and/or devices. The multiple different storage units and/or devices may or may not be of the same type or located at the same physical site. Furthermore, the data repository 610 may be implemented or executed on the same computing system as the resource modification orchestrator 606. Additionally, or alternatively, the data repository 610 may be implemented or executed on a computing system separate from the resource modification orchestrator 606. The data repository 610 may be communicatively coupled to the resource modification orchestrator 606 via a direct connection or via a network. Information describing the data repository 610 may be implemented across any of components of the system 600. However, the foregoing information is described with reference to the data repository 610 for purposes of clarity and explanation.

### 5. EXAMPLE OPERATIONS FOR ORCHESTRATING RESOURCE MODIFICATIONS

Referring now to FIGS. 7A-7D and FIGS. 8A-8D, example processes for orchestrating execution of resource modification operations are further described. One or more operations described with reference to FIGS. 7A-7D and FIGS. 8A-8D may be modified, rearranged, or omitted. Accordingly, the particular sequence of operations described with reference to FIGS. 7A-7D and FIGS. 8A-8D should not be construed as limiting the scope of one or more embodiments. In one example, the operations described with reference to FIGS. 7A-7D and FIGS. 8A-8D may be performed by the one or more components of the system described with reference to FIGS. 6A-6C.

### A. Example Operations for Orchestrating Execution of Resource Modifications

Referring to FIGS. 7A-7D, example operations 700 for orchestrating execution of resource modifications are further described. As shown in FIG. 7A, a system receives a request to execute a resource modification operation on any resources that meet a set of one or more resource selection criteria as of a time corresponding to performance of the resource modification operation (Operation 702). The system may receive the request from an operator device interface. Additionally, or alternatively, the system may receive the request from a resource modification orchestrator. In one example, the resource modification orchestrator generates the request in response to a trigger condition. The trigger condition may include an operational state of a computing environment where the set of one or more resources are executing. Additionally, or alternatively, the trigger condition may correspond to an operational state of one or more resources. Additionally, or alternatively, the trigger condition may correspond to a time interval, such as a time of day, a day of week, a week of year, or a time period.

In response to receiving the request to execute the resource modification operation, the system stores the resource modification operation in association with the set of one or more resource selection criteria and the time corresponding to performance of the resource modification operation (Operation 704). The system may store the resource modification operation in a schedule entry in a resource modification schedule. In one example, the system generates a resource modification schedule for storing the schedule entry. In one example, the system stores the schedule entry in an existing resource modification schedule. Operations pertaining to generating schedule entries in resource modification schedules are further described below with reference to FIG. 7B.

Subsequent to storing the schedule entry in the resource modification schedule, the system determines whether a time corresponding to performance of the resource modification operation has been detected (Operation 706). The time corresponding to performance of the resource modification operation may be an evaluation time for evaluating the set of one or more resource selection criteria corresponding to the resource modification operation to identify resources that satisfy the set of one or more resource selection criteria. The system may periodically or continuously monitor the current time against one or more evaluation times corresponding to one or more resource modification operations in the resource modification schedule. When the current time matches an evaluation time corresponding to performance of a resource modification operation, the system determines that the time corresponding to performance of the resource modification operation has been detected. When the current time does not match an evaluation time corresponding to performance of a resource modification operation, the system determines that the time corresponding to performance of the resource modification operation has not yet been detected. The system may utilize a set of timers or cron jobs that regularly compare the current time to evaluation times in the resource modification schedule.

In response to determining that a time corresponding to performance of a resource modification operation been detected, the system executes a resource identification operation based on the set of one or more resource selection criteria to identify at least one resource associated with a set of one or more attributes that satisfy the set of one or more resource selection criteria (Operation 708). The system may determine whether a resource satisfies the set of one or more resource selection criteria by comparing the set of one or more attributes associated with the resource against the resource selection criteria. Operations pertaining to identifying resources that satisfy resource selection criteria are further described below with reference to FIG. 7C.

In response to identifying a resource that satisfies the set of one or more resource selection criteria, the system initiates execution of the resource modification operation upon the resource (Operation 710). The resource modification operation may modify a configuration of the resource. The system may initiate execution of the resource modification operation by generating a set of one or more workflow instances for executing workflows that include executing the resource modification operation. Additionally, or alternatively, the system may initiate execution of the resource modification operation by storing a set of one or more work requests corresponding to the workflows in a workflow schedule. Operations pertaining to generating workflow instances are further described below with reference to FIG. 7D. Additionally, operations pertaining to generating work requests in a workflow schedule corresponding to workflow instances are further described below with reference to FIG. 7D.

i. Generating Schedule Entries in a Resource Modification Schedule

Referring to FIG. 7B, operations pertaining to generating schedule entries in resource modification schedules are further described. As shown in FIG. 7B, the system accesses a resource modification schedule (Operation 720). The resource modification schedule may be pre-existing, or the system may generate a new resource modification schedule. In one example, multiple resource modification schedules are accessible to the system. The system may generate different resource modification schedules based on a count of the resource modification operations. Different resource modification schedules may correspond to one or more of the following: different types of resource modification operations, different types of resources, different time period for executing resource modification operations, or different portions of a cloud environment. In one example, a first resource modification schedule corresponds to resource modification operations executed upon compute instances, and a second resource modification schedule corresponds to resource modification operations executed upon database instances. In one example, a third resource modification schedule corresponds to resource modification operations that include initiating execution of a resource, and a second resource modification schedule corresponds to resource modification operations that include pausing execution of a resource. The system may select a resource modification schedule that corresponds to a resource modification operation to be performed on any resources that meet a set of one or more resource selection criteria. In one example, the different resource modification schedules may include metadata that indicates the scope of the resource modification schedule, such as the types of resource modification operations, the types of resources, the time period, and/or the different portions of a cloud environment corresponding to the resource modification schedule. The system may select the resource modification schedule based on the metadata associated with the resource modification schedule. Additionally, or alternatively, the system may generate a new resource modification schedule, for example, if a resource modification operation does not fit the scope of the existing resource modification schedules.

Upon having accessed the applicable resource modification schedule, the system generates a schedule entry corresponding to the resource modification operation in the resource modification schedule (Operation 722). The schedule entry may include a time for evaluating a set of one or more resource selection criteria corresponding to the resource modification operation. Additionally, the schedule entry may include an indication of the resource modification operation and an indication of the resource selection criteria. The system may utilize a job scheduler or a task management tool to generate the schedule entries.

The system may determine whether there is an additional time for evaluating the resource selection criteria (Operation 724). In one example, the resource modification operation is repeated on a recurring basis. Different evaluation times may be associated with the different times when the resource modification operation is performed. When the system determines that there is an additional time for evaluating the resource selection criteria, the system generates an additional schedule entry (Operation 722). When the system determines that there is not an additional time for evaluating the resource selection criteria, the system ends the operations (Operation 726), for example, while awaiting an additional request to execute a resource modification operation at Operation 702 (FIG. 7A).

ii. Identifying Resources That Satisfy Resource Selection Criteria

Referring to FIG. 7C, operations pertaining to identifying resources that satisfy resource selection criteria are further described. In one example, multiple resource selection criteria may be associated with a resource modification operation. As shown in FIG. 7C, when there are multiple resource selection criteria, the system determines a resource selection criterion from the set of resource selection criteria for a resource identification operation (Operation 730). In one example, the system selects a first resource selection criterion from the set of resource selection criteria. Additionally, or alternatively, the system may determine the resource selection criterion based on one or more logical operators. In one example, the logical operators for determining the resource selection criterion may be configured to efficiently evaluate candidate resources against the multiple resource selection criteria.

Upon having selected or identified the resource selection criterion, the system determines a set of candidate resources for the first resource identification operation (Operation 732). The set of candidate resources may include all or a subset of resources executing in a portion of a cloud environment. In one example, the system may determine the set of candidate resources based on context associated with the resource selection criterion. For example, if the resource selection criterion pertains specifically to compute instances, the system may determine that the set of candidate resources includes compute instances. Additionally, or alternatively, the system may refrain from including resources in the set of candidate resources that are out of context for the resource selection criterion. For example, if the resource selection criterion pertains specifically to compute instances, the system may refrain from including resources that are not compute instances in the set of candidate resources. The system may utilize a resource identification module to identify the set of candidate resources. The resource identification module may query a resource attribute data corpus, and the system may return a query response that identifies the set of candidate resources.

Upon having identified the set of candidate resources, the system determines a candidate attribute, corresponding to the set of candidate resources, for evaluation against the resource selection criterion (Operation 734). In one example, the system may determine the set of candidate attributes based on the resource selection criterion. For example, the resource selection criterion may include an indication of a particular attribute to be evaluated against the resource selection criterion. The system may utilize a resource identification module to identify the set of candidate resources. The resource identification module may query a resource attribute data corpus, and the system may return a query response that identifies the set of candidate resources.

In one example, the resource selection criterion may indicate that the resource modification operation is to be applied to any resources that were generated by a particular user. The system may determine that a particular attribute that identifies a user that generated the particular candidate resource is a candidate attribute for evaluation against the resource selection criterion. Additionally, or alternatively, the resource selection criterion may identify a particular tag and/or a particular tag namespace for evaluation against the resource selection criterion. The system may determine that the particular tag and/or the particular tag namespace is a candidate attribute for evaluation against the resource selection criterion. In one example, the system may determine that a particular tag namespace is to be evaluated against the resource selection criterion. The system may select the tag namespace as a candidate attribute for evaluation against the resource selection criterion. Additionally, or alternatively, the system may select one or more tags contained within the tag namespace as candidate attributes. Additionally, or alternatively, the system may select a particular tag contained within a tag namespace as a candidate attribute.

In one example, the resource selection criterion may pertain to one or more properties, characteristics, or operational parameters associated with a resource, for example, without specifically identifying a particular attribute of the resource for evaluation against the resource selection criterion. Additionally, or alternatively, the resource selection criterion may include a keyword, for example, that may be satisfied by one or more attributes. Additionally, or alternatively, the resource selection criterion may be satisfied by multiple attributes, for example, without requiring a particular attribute and/or without specifically identifying a particular attribute.

The system may determine candidate attributes for evaluation against the resource selection criterion based on context associated with the resource selection criterion. For example, if the resource selection criterion pertains to an operational parameter, the system may determine that the set of candidate attributes includes a set of attributes that pertain to operational parameters that may contain content that satisfies the resource selection criterion. As another example, if the resource selection criterion pertains to compute instances, the system may determine that the set of candidate attributes includes a set of attributes that are relevant to compute instances. Additionally, or alternatively, the system may refrain from including attributes in the set of candidate attributes that are out of context for the resource selection criterion. For example, if the resource selection criterion pertains to an operational parameter, the system may refrain from including attributes that are not relevant to the operational parameter. As another example, if the resource selection criterion pertains specifically to compute instances, the system may refrain from including attributes that are not relevant to compute instances. As an example, when the resource criteria pertains specifically to compute instances, the system may refrain from including attributes that are specific to database instances.

Upon having identified a candidate attribute for evaluating a set of candidate resources against the resource selection criterion, the system executes the resource identification operation at least by filtering the set of candidate resources against the resource selection criterion based on the candidate attribute to determine whether one or more resources that satisfy the resource selection criterion (Operation 736). The system may identify one or more resources that satisfy the resource selection criterion utilizing the resource identification module. The resource identification module may execute a query upon a resource attribute data corpus based on the resource selection criterion. In one example, the query is directed to the set of candidate resources and/to the set of candidate attributes. Additionally, or alternatively, the query may be directed to all resources and/or all attributes. The system receives a query response that includes an indication of one or more resources that are associated with one or more attributes that satisfy the resource selection criterion. The system determines that the one or more resources from the query response satisfy the resource selection criterion, and the system selects the one or more resources from the query response as recipients of the resource modification operation.

Upon having executed the resource identification operation based on the candidate attribute, the system determines whether there is an additional candidate attribute that corresponds to the resource selection criterion (Operation 738). When the system determines that there is an additional candidate attribute correspond to the resource selection criterion, the system executes the resource identification operation at least by filtering the set of candidate resources against the resource selection criterion based on the additional candidate attribute to determine whether one or more resources that satisfy the resource selection criterion (Operation 736). When the system determines that there is not an additional candidate attribute that corresponds to the resource selection criterion, the system determines whether there is another resource selection criterion for the resource identification operation (Operation 730).

iii. Generating Workflow Instances and Work Requests

Referring to FIG. 7D, operations pertaining to generating workflow instances are further described. Additionally, operations pertaining to generating work requests in workflow schedules that correspond to the workflow instances are further described. As shown in FIG. 7D, the system selects a resource determined based on a resource identification operation corresponding to a resource modification operation (Operation 740).

Upon having selected the resource, the system generates a workflow instance for executing the resource modification operation upon the resource (Operation 742). Additionally, the system generates a work request for the workflow instance to execute a workflow (Operation 744). The work request is generated in the workflow schedule corresponding to the workflow instance. The workflow corresponding to the workflow instance includes accessing the resource and executing the resource modification operation upon the resource.

In one example, the system initiates identification or generation of one or more access policies for the workflow instance to execute the workflow (Operation 746). The one or more access policies may be identified and/or generated by an IAM system. The system may initialize identification and/or generation of an access policy by transmitting an access request to the IAM system. The access request may include information pertaining to the workflow instance that is to execute the workflow. Additionally, or alternatively, the request may include information pertaining to the resource corresponding to the workflow. Based on the information in the access request, the IAM system may identify one or more access policies in an access policy database that include permissions that provide a basis for authorizing the workflow instance to execute the workflow. Additionally, or alternatively, if the access policies available in the access policy database do not provide a sufficient basis for authorizing the workflow instance to execute the workflow, the IAM system may generate one or more access policies that provide the basis for authorizing the workflow instance to execute the workflow.

In response to the one or more access policies being generated or identified, the system obtains a credential representing authorization, in accordance with the one or more access policies, for the workflow instance to execute the workflow (Operation 748). The credential may be generated by the IAM system. The credential may include a token that the workflow instance presents to obtain authorization to access the resource and execute the resource modification operation upon the resource.

The workflow instance may utilize one or more scripts or templates that implement the resource modification operation. In one example, the system utilizes a workflow instance generation module to generate the workflow instance. Generation of the workflow instance may include incorporating the one or more scripts or templates into the workflow instance. The workflow instance may self-execute the one or more scripts or templates to perform the resource modification operation upon the resource. Additionally, or alternatively, the workflow instance may select the one or more scripts or tools for executing the resource modification operation from a data repository. The one or more scripts or tools may be selected by the workflow instance based on information pertaining to the resource and/or information pertaining to the resource modification operation to be executed upon the resource.

The system may generate workflow instances and workflow schedules for multiple resources identified by the resource identification operation. The different workflow instances and workflow schedules may be generated according to sequential and/or parallel operations. In one example, the system determines whether the resource identification operation identified an additional resource (Operation 750). When the system determines that the resource identification operation identified an additional resource, the system selects the resource (Operation 740) and generates an additional workflow instance (Operation 742) and an additional work request for the workflow instance to execute an additional workflow (Operation 744). Additionally, the system may initiate identification or generation of one or more access polices for the additional workflow instance to execute the additional workflow (Operation 746), and the system may obtain a credential representing authorization for the additional workflow instance to execute the additional workflow (Operation 748). When the system determines that the resource identification operation did not identify an additional resource, the system ends the operations (Operation 752), for example, while awaiting an additional resource identification operation.

### B. Example Operations for Generating Resource Modification Schedules

Referring to FIGS. 8A and 8B, example operations 800 for generating resource modification schedules are further described. The operations described with reference to FIGS. 8A and 8B may be executed to generate a resource modification schedule that includes one or more features described with reference to FIG. 6B.

As shown in FIG. 8A, the system generates a resource modification schedule that includes a set of schedule entries corresponding to a set of times for executing a resource identification operation (Operation 802). The system determines a count of the set of schedule entries (Operation 804). Additionally, the system determines whether the count of the set of schedule entries meets a threshold (Operation 806). In one example, the threshold is an upper threshold. When the system determines that the count of the set of schedule entries meets the threshold, the system generates an additional resource modification schedule (Operation 808). Additionally, or alternatively, the threshold may be a lower threshold. When the system determines that the count of the set of schedule entries meets the lower threshold, the system reduces the number of resource modification schedules.

Referring to FIG. 8B, the system receives a set of requests to execute a set of resource modification operations (Operation 820). The system generates a set of resource modification schedules based at least in part on a quantity of the requests (Operation 822). In one example, the system may include a threshold corresponding to a quantity of requests. When the quantity of requests meets the threshold, the system generates an additional resource modification schedule. In one example, the system may utilize the additional resource modification schedule for subsequent requests. Additionally, or alternatively, the system may reallocate one or more schedule entries from a previously existing resource modification schedule to the additional resource modification schedule.

In one example, the system determines a rate of receiving the set of requests to execute the set of resource modification operations (Operation 824). Additionally, the system determines whether the rate of receiving the requests meets a threshold (Operation 826). When the system determines that the rate of receiving the requests meets the threshold, the system scales the quantity of the resource modification schedules (Operation 828). When the system determines that the rate of receiving the requests does not meet the threshold, the system may continue determining the rate of receiving the requests (Operation 824), for example, on a periodic or continuous basis.

In one example, the system may compare the rate of receiving the requests to an upper threshold. When the rate of receiving the requests meets the upper threshold, the system may scale the quantity of the resource modification schedules by generating one or more additional resource modification schedules. The system may utilize the one or more additional resource modification schedules for subsequent requests, and/or the system may reallocate one or more schedule entries from a previously existing resource modification schedule to the one or more additional resource modification schedules. Additionally, or alternatively, the system may compare the rate of receiving the requests to a lower threshold. When the rate of receiving the requests meets the lower threshold, the system may scale the quantity of the resource modification schedules by consolidating at least one resource modification schedule with another resource modification schedule to reduce the total number of resource modification schedules.

### C. Example Operations for Generating Workflow Schedules

Referring to FIGS. 8C and 8D, example operations 850 for generating workflow schedules are further described. The operations described with reference to FIGS. 8C and 8D may be executed to generate a workflow schedule that includes one or more features described with reference to FIG. 6C.

As shown in FIG. 8C, the system generates a workflow schedule that includes a set of work requests for a set of workflow instances to execute workflows that include a resource modification operation (Operation 852). The system determines a count of the set of work requests (Operation 854). Additionally, the system determines whether the count of the set of work requests meets a threshold (Operation 856). In one example, the threshold is an upper threshold. When the system determines that the count of the set of work requests meets the threshold, the system generates an additional workflow schedule (Operation 858). Additionally, or alternatively, the threshold may be a lower threshold. When the system determines that the count of the set of work requests meets the lower threshold, the system reduces the number of workflow schedules.

Referring to FIG. 8D, the system generates a set of workflow instances for executing resource modification operations (Operation 870). Additionally, the system generates a set of workflow schedules (Operation 872). In one example, the quantity of the workflow schedules generated by the system is based at least in part on a quantity of the set of resource modification schedules. Additionally, or alternatively, the quantity of the workflow schedules generated by the system may be based at least in part on a quantity of the set of workflow instances.

In one example, the system scales the quantity of workflow schedules based on a rate of generating workflow instances. As shown in FIG. 8D, the system determines a rate of generating the set of workflow instances (Operation 874). Additionally, the system determines whether the rate of generating the set of workflow instances meets a threshold (Operation 876). When the system determines that the rate of generating the set of workflow instances meets the threshold, the system scales the quantity of the workflow schedules (Operation 878). When the determines that the rate of generating the set of workflow instances does not meet the threshold, the system may continue determining the rate of generating the set of workflow instances (Operation 874), for example, on a periodic or continuous basis.

In one example, the system may compare the rate of generating the set of workflow instances to an upper threshold. When the rate of generating the set of workflow instances meets the upper threshold, the system may scale the quantity of the workflow schedules by generating one or more additional workflow schedules. The system may utilize the one or more additional workflow schedules for subsequent work requests, and/or the system may reallocate one or more workflows from a previously existing workflow schedule to the one or more additional workflow schedules. Additionally, or alternatively, the system may compare the rate of generating the set of workflow instances to a lower threshold. When the rate of generating the set of workflow instances meets the lower threshold, the system may scale the quantity of the workflow schedules by consolidating at least one workflow schedule with another workflow schedule to reduce the total number of workflow schedules.

In one example, the system scales the quantity of workflow schedules based on a rate of generating resource modification schedules. As shown in FIG. 8D, the system determines a rate of generating the set of resource modification schedules (Operation 880). Additionally, the system determines whether the rate of generating the resource modification schedules meet a threshold (Operation 882). When the system determines that the rate of generating the resource modification schedules meets the threshold, the system scales the quantity of the workflow schedules (Operation 878). When the determines that the rate of generating the resource modification schedules does not meet the threshold, the system may continue determining the rate of generating the resource modification schedules (Operation 880), for example, on a periodic or continuous basis.

In one example, the system may compare the rate of generating the resource modification schedules to an upper threshold. When the rate of generating the resource modification schedules meets the upper threshold, the system may scale the quantity of the workflow schedules by generating one or more additional workflow schedules. The system may utilize the one or more additional workflow schedules for subsequent work requests, and/or the system may reallocate one or more workflows from a previously existing workflow schedule to the one or more additional workflow schedules. Additionally, or alternatively, the system may compare the rate of generating the resource modification schedules to a lower threshold. When the rate of resource modification schedules meets the lower threshold, the system may scale the quantity of the workflow schedules by consolidating at least one workflow schedule with another workflow schedule to reduce the total number of workflow schedules.

### 6. MISCELLANEOUS; EXTENSIONS

Embodiments are directed to a system with one or more devices that include a hardware processor and that are configured to perform any of the operations described herein and/or recited in any of the claims below. Embodiments are directed to a system that includes means to perform any of the operations described herein and/or recited in any of the claims below. In an embodiment, a non-transitory, computer-readable storage medium comprises instructions that, when executed by one or more hardware processors, causes performance of any of the operations described herein and/or recited in any of the claims.

Any combination of the features and functionalities described herein may be used in accordance with one or more embodiments. In the foregoing specification, embodiments have been described with reference to numerous specific details that may vary from implementation to implementation. Accordingly, the specification and drawings are to be regarded in an illustrative rather than a restrictive sense. The sole and exclusive indicator of the scope of patent protection, and what is intended by the applicants to be the scope of patent protection, is the literal and equivalent scope of the set of claims that issue from this application in the specific form that such claims issue, including any subsequent correction.

References, including publications, patent applications, and patents, cited herein are hereby incorporated by reference to the same extent as if the references were individually and specifically indicated to be incorporated by reference and were set forth in entirety herein.

What is claimed is:

1. A method, comprising:
receiving a first request to execute a first resource modification operation on any resources that meet a first set of one or more resource selection criteria as of at least a first time corresponding to the first resource modification operation;
storing the first resource modification operation in association with the first set of one or more resource selection criteria and at least the first time;
responsive to detecting the first time, executing a first resource identification operation based on the first set of one or more resource selection criteria to identify at least a first resource, associated with a first set of one or more attributes that satisfy the first set of one or more resource selection criteria;
initiating execution of the first resource modification operation upon the first resource to modify a first configuration corresponding to the first resource;
wherein the method is performed by at least one device including a hardware processor.

2. The method of claim 1, wherein executing the first resource identification operation comprises:
executing, upon a resource attribute data corpus, a first query based on the first set of one or more resource selection criteria;
receiving a first query response comprising a first indication that at least the first resource is associated with the first set of one or more attributes that satisfy the first set of one or more resource selection criteria;
selecting the first resource as a first recipient of the first resource modification operation to modify the first configuration corresponding to the first resource.

3. The method of claim 1, wherein executing the first resource identification operation comprises:
determining a first resource selection criteria, of the set of one or more resource selection criteria;
determining a set of candidate resources for the first resource identification operation;
determining a set of candidate attributes, including the first set of one or more attributes, corresponding to the set of candidate resources;
determining that the first set of one or more attributes correspond to the first resource selection criteria;
filtering the set of candidate resources, against the first resource selection criteria, based on the first set of one or more attributes to identify at least a first candidate resource, of the set of candidate resources, that satisfies the first set of one or more resource selection criteria.

4. The method of claim 3, wherein filtering the set of candidate resources comprises:
determining that a first metadata element associated with the first candidate resource of the set of candidate resources comprises a first attribute, of the first set of one or more attributes, that satisfies the first set of one or more resource selection criteria;
responsive at least in part to determining that the first attribute of the first metadata element satisfies the first set of one or more resource selection criteria:
selecting the first candidate resource as a first resource to receive the first resource modification operation to modify the first configuration corresponding to the first resource.

5. The method of claim 4, wherein filtering the set of candidate resources further comprises:
determining that the first set of one or more resource selection criteria is unmet by a second metadata element associated with a second candidate resource of the set of candidate resources;
responsive at least in part to determining that the first set of one or more resource selection criteria is unmet by the second metadata element associated with the second candidate resource:
refraining from selecting the second candidate resource to receive the first resource modification operation.

6. The method of claim 1, wherein receiving the first request to execute the first resource modification operation on any resources that meet the first set of one or more resource selection criteria comprises:
receiving an input comprising a selection, from an operator device interface, of the first set of one or more resource selection criteria.

7. The method of claim 1, wherein the first resource comprises one of: a database instance or a compute instance.

8. The method of claim 1, wherein the first resource modification operation comprises one of: initiating execution of the first resource, pausing execution of the first resource, or terminating execution of the first resource.

9. The method of claim 1, further comprising:
wherein storing the first resource modification operation in association with the first set of one or more resource selection criteria and at least the first time comprises:
generating, in a resource modification schedule, a set of schedule entries comprising a set of one or more evaluation times, including the first time, for evaluating the first set of one or more resource selection criteria corresponding to the first resource modification operation, wherein the set of schedule entries comprises a first schedule entry corresponding to the first time for executing the first resource modification operation;
wherein executing the first resource identification operation comprises:
determining, based on the resource modification schedule, the first schedule entry corresponding to the first time;
wherein initiating execution of the first resource modification operation upon the first resource comprises:
responsive at least in part to determining the first schedule entry corresponding to the first time:
generating a first workflow instance for executing the first resource modification operation upon the first resource, and
generating, in a workflow schedule, a first work request for the first workflow instance to execute a first workflow comprising accessing the first resource and executing the first resource modification operation upon the first resource,
wherein the first workflow instance executes the first workflow.

10. The method of claim 9, further comprising:
determining, based on the resource modification schedule, a second schedule entry corresponding to a second time, of the set of one or more evaluation times, for evaluating the first set of one or more resource selection criteria, wherein the set of schedule entries comprises the second schedule entry;
responsive to determining the second schedule entry corresponding to the second time, executing a second resource identification operation based on the first set of one or more resource selection criteria to identify at least a second resource, associated with a first set of one or more attributes that satisfy the first set of one or more resource selection criteria;
responsive at least in part to determining the second schedule entry corresponding to the second time:
generating a second workflow instance for executing the first resource modification operation upon the second resource, and
generating, in the workflow schedule, a second work request for the second workflow instance to execute a second workflow comprising accessing the second resource and executing the first resource modification operation upon the second resource,
wherein the second workflow instance executes the second workflow,
wherein the second resource is generated subsequent to execution of the first resource modification operation and prior to executing second resource identification operation.

11. The method of claim 1, further comprising:
receiving a second request to execute a second resource modification operation on any resources that meet a second set of one or more resource selection criteria as of at least a second time corresponding to the second resource modification operation;
storing the second resource modification operation in association with the second set of one or more resource selection criteria and at least the second time;
determining, at least by executing a second resource identification operation based on the second set of one or more resource selection criteria, that a second resource, associated with a second set of one or more attributes satisfies the second set of one or more resource selection criteria,
wherein the second set of one or more resource selection criteria is unmet by the first set of one or more attributes corresponding to the first resource;
responsive at least in part to determining that the second set of one or more attributes satisfies the second set of one or more resource selection criteria:
selecting the second resource to receive the second resource modification operation,
generating a second workflow instance for executing the second resource modification operation upon the second resource, and
generating, in a workflow schedule, a second work request for the second workflow instance to execute a second workflow comprising accessing the second resource and executing the second resource modification operation upon the second resource;
wherein the first configuration corresponding to the first resource is unmodified by the second resource modification operation.

12. The method of claim 1, wherein initiating execution of the first resource modification operation upon the first resource comprises:
determining, in a resource modification schedule comprising a set of schedule entries corresponding to a set of times for executing the first resource modification operation, a first schedule entry corresponding to the first time for executing the first resource modification operation;
responsive at least in part to determining the first schedule entry:
generating a first workflow instance for executing the first resource modification operation upon the first resource,
generating, in a workflow schedule, a first work request for the first workflow instance to execute a first workflow comprising accessing the first resource and executing the first resource modification operation upon the first resource,
obtaining a credential representing authorization, in accordance with one or more access policies corresponding to the first resource, for the first workflow instance to execute the first workflow,
wherein the first workflow instance utilizes the credential to executes the first workflow.

13. The method of claim 1, wherein executing the first resource identification operation comprises:
determining, based at least in part on an input comprising a selection, from an operator device interface, of a set of candidate resources for the first resource identification operation;
filtering the set of candidate resources, against the first set of one or more resource selection criteria, based on the first set of one or more attributes to identify a subset of the set of candidate resources, including at least the first resource, that satisfy the first set of one or more resource selection criteria.

14. The method of claim 1, further comprising:
receiving a plurality of requests to execute a plurality of resource modification operations, wherein the plurality of requests comprises the first request;
generating, based at least in part on a first quantity of the plurality of requests, a plurality of resource modification schedules, wherein generating the plurality of resource modification schedules comprises:
generating a first resource modification schedule comprising a first set of schedule entries corresponding to a first set of times for executing the first resource modification operation on a first plurality of resources, including the first resource;
generating a plurality of workflow instances for executing resource modification operations, wherein generating the plurality of workflow instances comprises:
generating a first plurality of workflow instances for executing a first plurality of workflows upon the first plurality of resources, wherein generating the first plurality of workflow instances comprises:
generating a first workflow instance for executing a first workflow, of the first plurality of workflows, comprising accessing the first resource and executing the first resource modification operation upon the first resource;
generating, based at least in part on a second quantity of the plurality of resource modification schedules or a third quantity of the plurality of workflow instances, a plurality of workflow schedules, wherein generating the plurality of workflow schedules comprises:
generating a first workflow schedule, corresponding to the first resource modification schedule, comprising a first set of work requests for the first plurality of workflow instances to execute the first plurality of workflows, wherein generating the first workflow schedule comprises:
generating a first work request for the first workflow instance to execute the first workflow;
wherein the plurality of workflow instance execute the first plurality of workflows approximately in accordance with the plurality of workflow schedules.

15. The method of claim 14, further comprising:
scaling the second quantity of the plurality of resource modification schedules based on a first rate of receiving the plurality of requests to execute the plurality of resource modification operations;
scaling a fourth quantity of the plurality of workflow schedules based on at least one of: a second rate of generating the plurality of resource modification schedules or a third rate of generating the plurality of workflow instances;
wherein scaling the second quantity and scaling the fourth quantity are performed independently of one another;
wherein the first rate differs from the second rate, and wherein the second rate differs from the third rate.

16. The method of claim 14, wherein generating the plurality of resource modification schedules comprises:
generating a second resource modification schedule comprising a second set of schedule entries corresponding to a second set of times for executing a second resource modification operation on a second plurality of resources;
determining that a first count of the second set of schedule entries meets a first threshold;
responsive at least in part to determining that the first count meets the first threshold, generating a third resource modification schedule comprising a third set of schedule entries corresponding to a third set of times for executing at least one of: (a) the second resource modification operation on a subset of the second plurality of resources, or (b) a third resource modification operation on a third plurality of resources;
wherein generating the plurality of workflow schedules comprises:
generating a second workflow schedule comprising a second set of work requests for a second plurality of workflow instances to execute a second plurality of workflows comprising executing a fourth resource modification operation upon a fourth plurality of resources;
determining that a second count of the second set of work requests meets a second threshold;
responsive at least in part to determining that the second count of the second set of work requests meets the second threshold, generating a third workflow schedule comprising a third set of work requests for a third plurality of workflow instances to execute a third plurality of workflows comprising at least one of: (c) executing the fourth resource modification operation upon a subset of the fourth plurality of resources, or (d) executing the fourth resource modification operation upon a fifth plurality of resources;
wherein the first threshold differs from the second threshold.

17. The method of claim 16, wherein generating the plurality of workflow schedules comprises:
determining a count of the second set of schedule entries;
determining a number of workflow schedules to be generated based at least in part on the count of the second set of schedule entries;
generating the plurality of workflow schedules in accordance with the number of workflow schedules to be generated.

18. The method of claim 16, wherein generating the plurality of workflow instances comprises:
determining a count of the second plurality of resources;
determining a number of the second plurality of workflow instances to be generated based at least in part on the count of the second plurality of resources;
generating the second plurality of workflow instances in accordance with the number of the second plurality of workflow instances to be generated,
wherein at least some of the second plurality of workflow instances execute the third resource modification operation upon at least two of the second plurality of resources.

19. One or more non-transitory computer-readable media comprising instructions that, when executed by one or more hardware processors, cause performance of operations comprising:
receiving a first request to execute a first resource modification operation on any resources that meet a first set of one or more resource selection criteria as of at least a first time corresponding to the first resource modification operation;
storing the first resource modification operation in association with the first set of one or more resource selection criteria and at least the first time;
responsive to detecting the first time, executing a first resource identification operation based on the first set of one or more resource selection criteria to identify at least a first resource, associated with a first set of one or more attributes that satisfy the first set of one or more resource selection criteria;
initiating execution of the first resource modification operation upon the first resource to modify a first configuration corresponding to the first resource.

20. A system comprising:
at least one device including a hardware processor;
the system being configured to perform operations comprising:
receiving a first request to execute a first resource modification operation on any resources that meet a first set of one or more resource selection criteria as of at least a first time corresponding to the first resource modification operation;
storing the first resource modification operation in association with the first set of one or more resource selection criteria and at least the first time;
responsive to detecting the first time, executing a first resource identification operation based on the first set of one or more resource selection criteria to identify at least a first resource, associated with a first set of one or more attributes that satisfy the first set of one or more resource selection criteria;
initiating execution of the first resource modification operation upon the first resource to modify a first configuration corresponding to the first resource.
